(19) United States
(12) Patent Application Publication
(10) Pub. No.: US 2026/0237756 A1
(43) Pub. Date: Aug. 13, 2026

(54) RECHARGEABLE ELECTROCHEMICAL CELLS, MANGANESE DIOXIDE PARTICLES AND METHODS FOR PRODUCTION THEREOF

(71) Applicant: THE UNIVERSITY OF BRITISH COLUMBIA, Vancouver (CA)

(72) Inventors: Bahar IRANPOUR, Vancouver (CA); John David Wyndham MADDEN, Vancouver (CA)

(73) Assignee: THE UNIVERSITY OF BRITISH COLUMBIA, Vancouver, BC (CA)

(21) Appl. No.: 19/149,702

(22) PCT Filed: Jan. 25, 2024
(86) PCT No.: PCT/CA2024/050083

§ 371 Date: Jul. 21, 2025

Related U.S. Application Data
(60) Provisional application No. 63/481,706, filed on Jan. 26, 2023.

(51) Int. Cl. H01M 10/26; H01M 4/38; H01M 4/50; H01M 4/66

(52) U.S. Cl. CPC H01M 10/26; H01M 4/38; H01M 4/50; H01M 4/663; H01M 2300/0005

(57) ABSTRACT

The present disclosure includes a method for preparing particles comprising MnO₂. For example, the method may comprise reacting a manganese (II) salt with an oxidizing agent in an aqueous environment at a pressure lower than about 0.2 MPa and a temperature of from about 40° C. to about 100° C. The MnO₂ particles may be useful, for example, as a cathode active material in electrochemical cells, such as those comprising a mildly acidic electrolyte. The present disclosure also includes rechargeable electrochemical cells comprising useful aqueous electrolytes.

### CROSS-REFERENCE TO RELATED APPLICATIONS

The present application claims the benefit of priority from co-pending U.S. provisional application No. 63/481,706 filed on Jan. 26, 2023, the contents of which are incorporated herein by reference in their entirety.

### FIELD

The present disclosure relates, for example, to electrochemical cells, MnO₂ particles and methods for the production thereof. The MnO₂ particles may be useful, for example, as a cathode active material in electrochemical cells, such as those comprising a mildly acidic electrolyte.

### BACKGROUND

Lithium-ion chemistry is an important field of research and development in the electrochemical energy storage landscape (Larcher and Tarascon, 2015). However, the use of hazardous organic electrolytes, high cost, and environmental impact could limit the large-scale deployment of such chemistry in the future (Larcher and Tarascon, 2015; Zhang and Liu, 2017). Therefore, exploration of alternative chemistries involving rechargeable aqueous batteries using water-based electrolytes has been undertaken. Mild, aqueous zinc-ion batteries (ZIBs) have the potential to outperform other chemistries due to the abundance of raw material resulting in low cost, as well as non-toxicity, low redox potential (−0.76 V vs. standard hydrogen electrode, SHE), high capacity (820 mA·h·g⁻¹), and a high overpotential for hydrogen evolution.

Among the new generation of ZIBs, the cyclability of a zinc-manganese dioxide battery paired with mildly acidic electrolyte, e.g., 1 to 2 M ZnSO₄ and 0.1 to 0.2 M MnSO₄ (at a pH of about 4), has been a major field of research (Oberholzer et al., 2019). The reaction mechanism of the system is generally considered to be a combination of Zn²⁺/H⁺ [de]insertion with cathode active material dissolution/redeposition while keeping a balance of Mn²⁺ ions by pre-addition of a small amount of MnSO₄ (Pan et al., 2016). However, issues with known Zn—MnO₂ batteries may include low mass loading of active material, an excess amount of zinc, limited low C-rate operation, low conductivity of MnO₂, side reactions (e.g., zinc corrosion and/or gas generation) and/or a complex mechanism under different C-rates (Li et al., 2019).

Manganese dioxide is used in industrial applications such as in battery or supercapacitor electrode manufacturing. Manganese dioxide used in commercial applications is often produced by either chemical or electrolytic methods. Manganese dioxide exhibits several polymorphs such as α-MnO₂, β-MnO₂, γ-MnO₂, δ-MnO₂, and δ-MnO₂. Due, for example, to low toxicity, low cost, and the abundance of MnO₂, this active material is used in the production of alkaline Zn/MnO₂ batteries and mildly acidic Zn/MnO₂ batteries. Hierarchical structures of MnO₂ have been prepared using a hydrothermal process (Zeng et al., 2010). During operation of an Zn/MnO₂ battery, zinc is oxidized, MnO₂ is reduced, and an electric current passing through an external load is generated. During charging, by-products formed during the reduction of MnO₂ are oxidized to manganese dioxide.

Although the theoretical chemistry demonstrates great potential, system stability while cycled at low C-rates (often below C and C=308 mA·h·g⁻¹ for 1 electron transfer) is unsatisfactory. While not wishing to be limited by theory, such insufficient cycling is mainly attributed to the quasi-reversible formation of a buffer zinc layered double hydroxide (ZnLDH), Zn₄(OH)₆SO₄·5H₂O, during cell discharge which precipitates/dissolves on both electrode surfaces because of electrolyte pH changes, activation of multiple species containing Mn (namely MnO₂, and Mn—Zn oxide phases), and hydrogen and possibly oxygen evolution on the surface of anode and cathode respectively (Alfaruqi et al., 2015; Fitz et al., 2021).

### SUMMARY

The present disclosure includes a method for preparing particles comprising MnO₂, the method comprising:
reacting a manganese (II) salt with an oxidizing agent in an aqueous environment at a pressure lower than about 0.2 MPa and a temperature of from about 40° C. to about 100° C. to produce the particles comprising the MnO₂.

In an embodiment, the reaction is carried out at ambient pressure.

In an embodiment, the manganese (II) salt comprises MnSO₄.

In an embodiment, the oxidizing agent is a persulfate. In another embodiment, the oxidizing agent comprises (NH₄)₂S₂O₈.

In an embodiment, the concentration of the manganese (II) salt and the oxidizing agent in the aqueous environment is from about 0.05 M to about 0.5 M.

In an embodiment, the method comprises adding the oxidizing agent to an aqueous solution comprising the manganese (II) salt.

In an embodiment, the reaction is carried out at a temperature of from about 70° C. to about 100° C. In another embodiment, the reaction is carried out at a temperature of from about 80° C. to about 90° C.

In an embodiment, the reaction is carried out for a time of about 2 hours to about 6 hours. In another embodiment, the reaction is carried out for a time of about 3 hours to about 4 hours.

In an embodiment, the method comprises agitation during the reaction.

In an embodiment, the method further comprises separating the particles comprising the MnO₂ from the aqueous environment. In another embodiment, the method further comprises washing the separated particles comprising the MnO₂. In a further embodiment, the method further comprises drying the separated and optionally washed particles comprising the MnO₂.

In an embodiment, the method further comprises reacting the manganese (II) salt with the oxidizing agent in the presence of a carbon-based material to obtain the particles comprising MnO₂ in the form of a composite comprising the MnO₂ deposited on the surface of the carbon-based material. In another embodiment, the carbon-based material is selected from graphene, carbon nanofibers (CNF), carbon nanotubes (CNT), carbon black (CB) and mixtures thereof.

The present disclosure also includes a particle comprising MnO₂ prepared by a method for preparing particles comprising MnO₂ as described herein.

The present disclosure also includes a particle comprising MnO₂, wherein the particle is substantially spherical and comprises rod-like extensions with flat ends radiating outwardly from the center of the particle. In an embodiment, the rod-like extensions have an average length of about 200 nm to about 500 nm and an average width of about 20 nm to about 50 nm.

In an embodiment, the average diameter of the particle is from about 1.5 μm to about 4 μm. In an embodiment, the Brunauer-Emmett-Teller (B.E.T.) surface area of the particle is from about 35 m²/g to about 100 m²/g. In an embodiment, the MnO₂ comprises γ-MnO₂.

The present disclosure also includes a cathode comprising a particle comprising MnO₂ as described herein and/or prepared by a method for preparing particles comprising MnO₂ as described herein. The present disclosure also includes an electrochemical cell comprising such a cathode.

The present disclosure also includes a rechargeable electrochemical cell, comprising:
a cathode comprising a particle comprising MnO₂ as described herein and/or prepared by a method for preparing particles comprising MnO₂ as described herein;
an anode comprising zinc; and
an aqueous electrolyte comprising a zinc salt and optionally a manganese salt, wherein the aqueous electrolyte has a pH of from about 3 to about 7.

In an embodiment, the rechargeable electrochemical cell further comprises a separator separating the cathode and the anode.

In an embodiment, the aqueous electrolyte has a pH of from about 3.8 to about 5.

In an embodiment, the zinc salt is zinc sulfate and the aqueous electrolyte comprises the manganese salt, wherein the manganese salt is manganese (II) sulfate.

In an embodiment, the aqueous electrolyte further comprises an alkali metal salt, an alkaline earth metal salt, an anionic surfactant, ethylene glycol, silicon dioxide or combinations thereof.

In an embodiment, the aqueous electrolyte comprises zinc sulfate, manganese (II) sulfate and magnesium sulfate.

In an embodiment, the aqueous electrolyte comprises the ethylene glycol.

In an embodiment, the aqueous electrolyte comprises the anionic surfactant and the anionic surfactant is magnesium lauryl sulfate, potassium lauryl sulfate, lithium lauryl sulfate or combinations thereof. In another embodiment, the anionic surfactant is magnesium lauryl sulfate.

In an embodiment, the anode comprising zinc is a zinc foil that has been etched with acid. In another embodiment, the etching with acid is for a time of about 1 minute with sulfuric acid having a concentration of about 3 M.

In an embodiment, the cathode is deposited on a carbon-based current collector comprising graphite foil, carbon fiber paper, carbon cloth or combinations thereof.

In an embodiment, the rechargeable electrochemical cell is a coin cell, a cylindrical cell, a pouch cell or a prismatic cell.

The present disclosure also includes a rechargeable electrochemical cell, comprising:
a cathode;
an anode comprising zinc; and
an aqueous electrolyte comprising a zinc salt, a manganese salt, and an alkali metal salt, an alkaline earth metal salt or combinations thereof,
wherein the aqueous electrolyte has a pH of from about 3 to about 7.

In an embodiment, the zinc salt is zinc sulfate, and the manganese salt is manganese (II) sulfate.

In an embodiment, the aqueous electrolyte comprises the alkali metal salt. In another embodiment, the alkali metal salt is potassium sulfate.

In an embodiment, the aqueous electrolyte comprises the alkaline earth metal salt. in another embodiment, the alkaline earth metal salt is magnesium sulfate.

In an embodiment, the aqueous electrolyte comprises about 1 M zinc sulfate, about 0.1 M manganese (II) sulfate and about 0.5 M magnesium sulfate.

In an embodiment, the rechargeable electrochemical cell further comprises a separator separating the cathode and the anode.

In an embodiment, the aqueous electrolyte has a pH of from about 3.8 to about 5.

In an embodiment, the aqueous electrolyte further comprises an anionic surfactant. In another embodiment, the anionic surfactant is magnesium lauryl sulfate, potassium lauryl sulfate, lithium lauryl sulfate or combinations thereof. In a further embodiment, the anionic surfactant is magnesium lauryl sulfate.

In an embodiment, the aqueous electrolyte further comprises ethylene glycol.

In an embodiment, the aqueous electrolyte comprises at least about 0.5 vol % ethylene glycol mixed with a secondary organic additive agent selected from salicylaldehyde (SAL), benzylideneacetone (BDA), benzylacetone (BA), butylbenzene (BB) and combinations thereof.

In an embodiment, the aqueous electrolyte further comprises silicon dioxide.

In an embodiment, the cathode comprises a manganese oxide, a zinc manganese oxide, a manganese-zinc hydrated sulfate hydroxide, a zinc hydroxide sulfate hydrate, or combinations thereof. In another embodiment, the cathode comprises MnO₂. In a further embodiment, the MnO₂ is undoped MnO₂. In an embodiment, the MnO₂ comprises γ-MnO₂. In another embodiment, the MnO₂ comprises MnO₂ particles having a hierarchical structure.

In an embodiment, the anode comprising zinc is a zinc foil.

In an embodiment, the anode comprising zinc has been etched with acid. In another embodiment, the etching with acid is for a time of about 1 minute with sulfuric acid having a concentration of about 3 M.

In an embodiment, the rechargeable electrochemical cell further comprises a cathode current collector. In an embodiment, the cathode is deposited on a carbon-based current collector comprising graphite foil, carbon fiber paper, carbon cloth or combinations thereof.

In an embodiment, the rechargeable electrochemical cell is a coin cell, a cylindrical cell, a pouch cell or a prismatic cell.

The present disclosure also includes a rechargeable electrochemical cell, comprising:
a cathode;
an anode comprising zinc; and
an aqueous electrolyte comprising:
   a zinc salt;
   a lithium salt of an anionic surfactant, a potassium salt of an anionic surfactant, a magnesium salt of an anionic surfactant or combinations thereof; and
   optionally a manganese salt, an alkali metal salt, an alkaline earth metal salt or combinations thereof,
wherein the aqueous electrolyte has a pH of from about 3 to about 7.

In an embodiment, the zinc salt is zinc sulfate and the aqueous electrolyte comprises the manganese salt, wherein the manganese salt is manganese (II) sulfate.

In an embodiment, the aqueous electrolyte comprises the alkali metal salt. In another embodiment, the alkali metal salt is potassium sulfate.

In an embodiment, the aqueous electrolyte comprises the alkaline earth metal salt. In another embodiment, the alkaline earth metal salt is magnesium sulfate.

In an embodiment, the aqueous electrolyte comprises about 1 M zinc sulfate, about 0.1 M manganese (II) sulfate and about 0.5 M magnesium sulfate.

In an embodiment, the rechargeable electrochemical cell further comprises a separator separating the cathode and the anode.

In an embodiment, the aqueous electrolyte has a pH of from about 3.8 to about 5.

In an embodiment, the aqueous electrolyte comprises the magnesium salt of the anionic surfactant and wherein the anionic surfactant is magnesium lauryl sulfate.

In an embodiment, the aqueous electrolyte further comprises ethylene glycol.

In an embodiment, the aqueous electrolyte comprises at least about 0.5 vol % ethylene glycol mixed with a secondary organic additive agent selected from salicylaldehyde (SAL), benzylideneacetone (BDA), benzylacetone (BA), butylbenzene (BB) and combinations thereof.

In an embodiment, the aqueous electrolyte further comprises silicon dioxide.

In an embodiment, the cathode comprises a manganese oxide, a zinc manganese oxide, a manganese-zinc hydrated sulfate hydroxide, a zinc hydroxide sulfate hydrate, or combinations thereof. In another embodiment, the cathode comprises MnO₂. In a further embodiment, the MnO₂ is undoped MnO₂. In an embodiment, the MnO₂ comprises γ-MnO₂. In another embodiment, the MnO₂ comprises MnO₂ particles having a hierarchical structure. In an embodiment, the anode comprising zinc is a zinc foil.

In an embodiment, the anode comprising zinc has been etched with acid. In another embodiment, the etching with acid is for a time of about 1 minute with sulfuric acid having a concentration of about 3 M.

In another embodiment, the rechargeable electrochemical cell further comprises a cathode current collector. In an embodiment, the cathode is deposited on a carbon-based current collector comprising graphite foil, carbon fiber paper, carbon cloth or combinations thereof.

In an embodiment, the rechargeable electrochemical cell is a coin cell, a cylindrical cell, a pouch cell or a prismatic cell.

The present disclosure also includes a use of a lithium salt of an anionic surfactant, a potassium salt of an anionic surfactant, a magnesium salt of an anionic surfactant or combinations thereof in an aqueous electrolyte for a rechargeable electrochemical cell. The present disclosure also includes an aqueous electrolyte comprising a lithium salt of an anionic surfactant, a potassium salt of an anionic surfactant, a magnesium salt of an anionic surfactant or combinations thereof for use in a rechargeable electrochemical cell. In an embodiment, corrosion resistance of the anode in the rechargeable electrochemical cell is increased. In an embodiment, hydrogen evolution in the rechargeable electrochemical cell is decreased. In another embodiment, the aqueous electrolyte comprises the magnesium salt of the anionic surfactant and the anionic surfactant is magnesium lauryl sulfate.

The present disclosure also includes a method of preparing an anode comprising zinc for use in an electrochemical cell, the method comprising contacting the zinc with an acid to etch a surface of the zinc. In an embodiment, the acid is an inorganic acid. In another embodiment, the acid is sulfuric acid. In a further embodiment, the etching with acid is for a time of about 1 minute with sulfuric acid having a concentration of about 3 M.

In an embodiment, the electrochemical cell is a rechargeable electrochemical cell. In an embodiment, the rechargeable electrochemical cell is a rechargeable electrochemical cell comprising: a cathode comprising a particle comprising MnO₂ as described herein and/or prepared by a method for preparing particles comprising MnO₂ as described herein; an anode comprising zinc; and an aqueous electrolyte comprising a zinc salt and optionally a manganese salt, wherein the aqueous electrolyte has a pH e.g., of from about 3 to about 7 as described herein. In another embodiment, the rechargeable electrochemical cell is a rechargeable electrochemical cell comprising: a cathode; an anode comprising zinc; and an aqueous electrolyte comprising a zinc salt, a manganese salt, and an alkali metal salt, an alkaline earth metal salt or combinations thereof, wherein the aqueous electrolyte has a pH e.g., of from about 3 to about 7 as described herein. In a further embodiment, the rechargeable electrochemical cell is a rechargeable electrochemical cell comprising: a cathode; an anode comprising zinc; and an aqueous electrolyte comprising: a zinc salt; a lithium salt of an anionic surfactant, a potassium salt of an anionic surfactant, a magnesium salt of an anionic surfactant or combinations thereof; and optionally a manganese salt, an alkali metal salt, an alkaline earth metal salt or combinations thereof, wherein the aqueous electrolyte has a pH e.g., of from about 3 to about 7 as described herein.

Other features and advantages of the present disclosure will become apparent from the following detailed description. It should be understood, however, that the detailed description and the specific examples, while indicating embodiments of the disclosure, are given by way of illustration only and the scope of the claims should not be limited by these embodiments, but should rather be given the broadest interpretation consistent with the description as a whole.

### BRIEF DESCRIPTION OF THE DRAWINGS

The embodiments of the disclosure will now be described in greater detail with reference to the attached drawings, in which:

FIG. 1 shows an exemplary scanning electron microscopy (SEM) image showing the γ-MnO₂ particles from a process carried out at 80° C. at ambient pressure for 3 hours (upper image) and exemplary SEM images of the particles from a process carried out at 80° C. at ambient pressure for 3 hours enlarged to show the spike-like surface structure (middle and lower images). Scale bars show 20 μm (upper image), 2 μm (middle image) and 1 μm (lower image).

FIG. 2 is an exemplary SEM image showing γ-MnO₂ particles from a hydrothermal process carried out at 90° C. in a sealed autoclave for 12 hours. Scale bar shows 2 μm.

FIG. 3 is a plot of the first discharge voltage profile (voltage vs mAh/g MnO₂) in Mg-electrolyte at C/8 constant current discharge, comparing performance of MnO₂ from a process carried out at 80° C. at ambient pressure for 3 hours (*) with conventional hydrothermally prepared MnO₂ (**).

FIG. 4 shows exemplary SEM images of particle evolution of MnO₂ products prepared from a process carried out at 80° C. at ambient pressure after 2 hours (upper image), 4 hours (middle image), and 6 hours (lower image). Scale bars in each image show 2 μm.

FIG. 5 shows exemplary SEM images showing the MnO₂ products from a process carried out at 60° C. at ambient pressure for 10 hours. Scale bar in upper image shows 20 μm. Scale bar in lower image shows 4 μm.

FIG. 6 shows exemplary SEM images showing the MnO₂ products from a process carried out at 60° C. at ambient pressure for 36 hours. Scale bar in upper image shows 20 μm. Scale bar in lower image shows 4 μm.

FIG. 7 shows an X-ray powder diffraction (XRD) spectrum showing the peaks for MnO₂ products from a process carried out at 60° C. after 10 hours (upper), and after 36 hours (lower) at ambient pressure (top image) in comparison to data for exemplary forms of MnO₂ (bottom image).

FIG. 8 shows exemplary SEM images showing the MnO₂ products from a process carried out at 70° C. at ambient pressure for 7 hours. Scale bar in upper image shows 2 μm. Scale bar in lower image shows 5 μm.

FIG. 9 is an XRD spectrum showing the peaks for MnO₂ products from a process carried out at 70° C. and 7 hours duration at ambient pressure.

FIG. 10 shows an exemplary SEM image showing the γ-MnO₂ products from a process carried out at 90° C. at ambient pressure for 4 hours. Scale bar shows 2 μm.

FIG. 11 shows exemplary SEM images of γ-MnO₂ particles synthesized from a process carried out at 80° C. at ambient pressure after 4 hours in 80 ml water (upper left image), from a process carried out at 80° C. at ambient pressure after 4 hours in 30 ml water (upper right image), from a hydrothermal process carried out at 90° C. in an autoclave after 12 hours in 80 ml water (lower left image), and from a hydrothermal process carried out at 90° C. in an autoclave after 12 hours in 30 ml water (lower right image). Scale bars show 2 μm (upper left image), 3 μm (upper right image) and 4 μm (lower images).

FIG. 12 is a galvanostatic charge/discharge cycle plot comparison of γ-MnO₂ chemically synthesized on a hot plate (* and **), in comparison to MnO₂ hydrothermally (HT) synthesized (♦ and ♦♦) cycled in an Mg-electrolyte at C/3 constant current discharge/charge (Specific Capacity mAh/g of active MnO₂).

FIG. 13 shows an exemplary SEM image of γ-MnO₂ deposited on untreated carbon nanofibers (CNF) through a chemical reaction carried out at 90° C. at ambient pressure (upper image) and an exemplary SEM image of the MnO₂/CNF composite product shown in the upper image enlarged to show the regular needle-like structures growing on the CNF surface (lower image). Scale bar in upper image shows 20 μm. Scale bar in lower image shows 2 μm.

FIG. 14 shows exemplary SEM images of γ-MnO₂ synthesized in the presence of untreated carbon nanofibers (CNF) through a hydrothermal reaction in a sealed autoclave carried out at 90° C. for 12 hours (upper and middle images) and an exemplary SEM image of the MnO₂/CNF composite product shown in the upper images enlarged to show irregular urchin shapes are not growing around the CNF surface (bottom image). Scale bar in top image shows 20 μm and in the middle image shows 10 μm. Scale bar in lower image shows 5 μm.

FIG. 15 is a first discharge plot of the voltage profile (voltage vs mAh/g MnO₂) in an Mg-electrolyte at C/8 constant current discharge, comparing performance of a CNF/MnO₂ composite chemically synthesized on a hot plate (*) with a hydrothermally prepared CNF/MnO₂ composite (**).

FIG. 16 is a schematic illustrating an exemplary coin cell setup with internal components including a zinc anode, a separator, and a manganese dioxide cathode capable of producing an open circuit voltage of about 1.45 V in the presence of aqueous electrolyte.

FIG. 17 is a schematic illustrating a quartz cuvette with a gas outlet and internal components including a zinc anode, a separator, and a manganese dioxide cathode capable of producing an open circuit voltage of about 1.45 V in the presence of aqueous electrolyte.

FIG. 18 illustrates the C/3 constant current cycling results of an exemplary coin cell battery with additive salt: 1M ZnSO₄ and 0.1M MnSO₄ with 0.5M MgSO₄ (*), in comparison to a coin cell battery without additive salt: 1M ZnSO₄ and 0.1M MnSO₄ (**).

FIG. 19 illustrates the long rest time cycling protocol results for an exemplary coin cell battery with additive salt: 1M ZnSO₄ and 0.1M MnSO₄ with 0.5M MgSO₄.

FIG. 20 shows photographs illustrating an exemplary 70 μm thickness Zn anode foil after C/4 constant current cycling in standard electrolyte after about 120 cycles (upper image) in comparison to an electrolyte with 0.5M MgSO₄ salt additive after about 200 cycles (lower image).

FIG. 21 illustrates exemplary coin cell Zn/Zn symmetric cycling at 2 mA/cm² for about 400 hours in standard electrolyte (1M ZnSO₄ and 0.1M MnSO₄). Voltage-drop and short circuit was observed at about 180 hours. Inset shows enlarged voltage-time plot at a dendritic short-circuit after 210 hours and after recovery from the first soft shorting at about 180 hours.

FIG. 22 illustrates exemplary coin cell Zn/Zn symmetric cycling at 2 mA/cm² for about 720 hours with electrolyte including 1M ZnSO₄, 0.1M MnSO₄ and 0.5M MgSO₄. Insert shows enlarged voltage-time plot of untreated zinc symmetric cycles exhibiting peaking behaviour.

FIG. 23 illustrates the C/4 constant current cycling results of exemplary coin cell batteries with electrolyte including: 1M ZnSO₄ and 0.5M MgSO₄ (♦) 1M ZnSO₄, 0.5M MgSO₄ and 0.5 vol % ethylene glycol, EG (♦♦), 1M ZnSO₄, 0.5M MgSO₄, 0.5 vol % EG and 0.01M sodium dodecyl sulfate, SDS (♦♦♦), 1M ZnSO₄, 0.1M MnSO₄ and 0.5M MgSO₄ (*), 1M ZnSO₄, 0.1 M MnSO₄, 0.5M MgSO₄ and 0.5 vol % EG (**), and 1M ZnSO₄, 0.1M MnSO₄, 0.5M MgSO₄, 0.5 vol % EG and 0.01M SDS (***).

FIG. 24 illustrates the C/3 constant current cycling results of an exemplary coin cell battery with electrolyte including 1M ZnSO₄, 0.1 M MnSO₄, 0.5M MgSO₄, and 0.5 mM magnesium lauryl sulfate. The Zn electrodes were etched in 3M H₂SO₄ for 1 minute.

FIG. 25 illustrates exemplary coin cell Zn/Zn symmetric cycling at 2 mA/cm² for about 960 hours with electrolyte including 1M ZnSO₄, 0.1M MnSO₄, 0.5M MgSO₄, and 0.5 mM magnesium lauryl sulfate. The Zn electrodes were etched in 3M H₂SO₄ for 1 minute. Inset shows an enlarged portion of the voltage profile of the symmetric cell after 756 hours.

FIG. 26 illustrates the C/4 constant current cycling results of an exemplary coin cell battery with electrolyte including 1M ZnSO₄, 0.1 M MnSO₄, 0.5M Li₂SO₄, and 0.5 mM magnesium lauryl sulfate. The Zn electrodes were etched in 3M H₂SO₄ for 1 minute.

FIG. 27 illustrates the C/4 constant current cycling results of an exemplary coin cell battery with electrolyte including 1M ZnSO₄, 0.1 M MnSO₄, and 0.5M Li₂SO₄. The Zn electrodes were etched in 3M H₂SO₄ for 1 minute.

FIG. 28 shows exemplary SEM images of zinc treated with 1M H₂SO₄ (top row), 3M H₂SO₄ (middle row) and 5M H₂SO₄ (bottom row) for 1 minute. Scale bars show 10 μm (top left and middle left images), 5 μm (bottom left image) and 2 μm (top, middle and bottom right images).

FIG. 29 illustrates exemplary coin cell Zn/Zn symmetric cycling at 3.5 mA/cm² for about 3900 hours with electrolyte including 1M ZnSO₄, 0.1M MnSO₄ and 0.5M MgSO₄. The Zn electrodes were etched in 3M H₂SO₄ for 1 minute. Insets show enlarged portions of the voltage-time plot of the zinc symmetric cell after 1000 hours (left) and 3200 hours (right).

FIG. 30 shows exemplary SEM images of a Zn surface etched with 3M H₂SO₄ (right images) in comparison to a Zn surface that was not etched (left images) after 350 cycles when used as an anode in a battery with an electrolyte including 1M ZnSO₄, 0.1M MnSO₄, and 0.5M MgSO₄. Scale bars show 4 μm (upper images) and 20 μm (lower images).

FIG. 31 shows exemplary photographs of a battery in a quartz cuvette having an electrolyte including 1M ZnSO₄, 0.1M MnSO₄ and 0.23M K₂SO₄ (upper left image); a battery in a quartz cuvette having an electrolyte including 1M ZnSO₄, 0.1M MnSO₄ and 0.23M K₂SO₄ and with a zinc electrode etched for 1 minute in 3M H₂SO₄ (upper right image); a battery in a quartz cuvette having an electrolyte including 1M ZnSO₄, 0.1M MnSO₄ and 0.5M MgSO₄ with a zinc electrode etched for 1 minute in 3M H₂SO₄ (lower left image); and a battery in a quartz cuvette having an electrolyte including 1M ZnSO₄, 0.1M MnSO₄, 0.5M MgSO₄ and 0.5 vol % ethylene glycol and with a zinc electrode etched for 1 minute in 3M H₂SO₄ (lower right image).

FIG. 32 illustrates exemplary coin cell Zn/Zn symmetric cycling at 2 mA/cm² for about 3198 hours with electrolyte including 1M ZnSO₄, 0.1M MnSO₄, 0.5M MgSO₄, and 0.5 vol % ethylene glycol (EG). The Zn electrodes were etched in 3M H₂SO₄ for 1 minute. Inset shows an enlarged portion of the voltage profile of the symmetric cell after 600 hours of cycling.

FIG. 33 illustrates the C/3 constant current cycling results of an exemplary coin cell battery with electrolyte including 1M ZnSO₄, 0.1 M MnSO₄, 0.5M MgSO₄, 0.5 vol % EG and 10 wt. % SiO₂.

FIG. 34 shows exemplary SEM images of γ-MnO₂ particles synthesized from a hydrothermal process carried out at 80° C. in an autoclave after 12 hours in 80 ml water (upper left image), from a hydrothermal process carried out at 90° C. in an autoclave after 12 hours in 80 ml water (upper right image), from a hydrothermal process carried out at 100° C. in an autoclave after 12 hours in 80 ml water (lower left image), and from a process comprising salt reduction carried out at room temperature (lower right image). Scale bars show 4 μm (upper left image) and 2 μm (upper right image and lower images).

FIG. 35 shows exemplary XRD spectra showing the peaks for γ-MnO₂ hydrothermally synthesized at 80, 90, and 100° C. and MnO₂ produced via a room temperature redox reaction.

FIG. 36 shows the first charge, second discharge galvanostatic plots of the γ-MnO₂ of FIG. 35 in standard electrolyte (upper) and potassium-containing electrolyte (lower) at a rate of 0.25C.

FIG. 37 shows cycling performance of γ-MnO₂ hydrothermally synthesized at 100° C. (upper left), 90° C. (upper right), and 80° C. (lower left) and γ-MnO₂ produced via a room temperature redox reaction (lower right) in potassium-containing electrolyte and standard electrolyte at 0.25C.

### DETAILED DESCRIPTION

### I. Definitions

Unless otherwise indicated, the definitions and embodiments described in this and other sections are intended to be applicable to all embodiments and aspects of the disclosure herein described for which they would be understood to be suitable by a person skilled in the art.

As used herein, the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process/method steps. As used herein, the word “consisting” and its derivatives, are intended to be close ended terms that specify the presence of stated features, elements, components, groups, integers, and/or steps, and also exclude the presence of other unstated features, elements, components, groups, integers and/or steps. The term “consisting essentially of” and any form thereof, as used herein, is intended to specify the presence of the stated features, elements, components, groups, integers, and/or steps as well as those that do not materially affect the basic and novel characteristic(s) of these features, elements, components, groups, integers, and/or steps.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

As used in this disclosure, the singular forms “a”, “an” and “the” include plural references unless the content clearly dictates otherwise.

The term “and/or” as used herein means that the listed items are present, or used, individually or in combination. In effect, this term means that “at least one of” or “one or more” of the listed items is used or present.

The term “suitable” as used herein means that the selection of specific reagents and/or conditions will depend on the reaction being performed and the desired results, but nonetheless, can generally be made by a person skilled in the art once all relevant information is known.

The term “surfactant” as used herein refers to a substance capable of lowering the surface tension between, for example, two liquids, a liquid and a solid and/or a liquid and a gas. Surfactants are compounds that typically comprise one or more hydrophilic head groups and one or more hydrophobic tail groups. The term “anionic surfactant” as used herein refers to a surfactant wherein the hydrophilic group is an anionic group. Suitable anionic groups may include a sulfate, sulfonate, phosphate or carboxylate. Suitable hydrophobic tail groups may include a hydrocarbon chain, optionally including one or more sites of branching, unsaturation and/or heteroatoms (e.g., oxygen such as in a tail group comprising a polyether), a fluorocarbon, or a siloxane. In an embodiment, the hydrophobic tail group comprises a linear hydrocarbon. In an embodiment, the linear hydrocarbon has from 10 to 14 carbon atoms, e.g., 12 carbon atoms. The anionic surfactants also comprise a positively charged countercation. Suitable positively charged counteractions may include lithium ion, sodium ion, potassium ion or magnesium ion. However, in some embodiments of the present disclosure, the positively charged counteraction is other than sodium ion.

### II. MnO₂ Particles, Electrochemical Cells and Methods

Hierarchical, substantially spherical MnO₂ particles were prepared by reacting manganese (II) sulfate and ammonium persulfate in an aqueous solution at ambient pressure. Addition of carbon nanofibers in the aqueous solution during synthesis allowed for MnO₂ nanowire growth on the surface of the fibers. When used as an electrode in a Zn/MnO₂ rechargeable battery in a mildly acidic environment, the specific capacity was compatible to “sea-urchin” MnO₂ morphology synthesized through more complicated methods such as sol-gel and hydrothermal methods. The particles were found to contain gamma MnO₂. Depending, for example, on the temperature, time and/or concentration of reagents, manganese dioxide particles can be prepared with rod-like extensions with flat ends radiating outwardly from the center of the particle, having an average length of from about 200 nm to about 500 nm and an average diameter of about 20 nm to about 50 nm as measured from SEM images. The MnO₂ particles prepared by such a method may, for example, have desirable purity and/or uniformity, in addition, the preparation method has the advantage of time savings, simplicity, and/or low cost in contrast to other methods such as a hydrothermal method, which may be useful, for example, in large-scale production. Moreover, no template or surfactant was introduced in the reaction. When the MnO₂ was deposited on carbon fibers dispersed in solution during synthesis, its specific capacity exceeded the capacity of pure MnO₂. Initial test results showed that the MnO₂/CNF composite material had the advantage of an active material with improved conductivity and cyclic stability of material at higher mass loading.

Accordingly, the present disclosure includes a method for preparing particles comprising MnO₂, the method comprising:
reacting a manganese (II) salt with an oxidizing agent in an aqueous environment at a pressure e.g., lower than about 0.2 MPa and a temperature of from about 40° C. to about 100° C. to produce the particles comprising the MnO₂.

A person skilled in the art would appreciate that a suitable pressure for the method for preparing particles comprising MnO₂ of the present disclosure is significantly lower than the typical pressures used in hydrothermal synthesis which is carried out in a closed reaction vessel (e.g., an autoclave) under high pressures such as a pressure of about 2 MPa to about 3 MPa. Accordingly, in an embodiment, the reaction is carried out at a pressure of lower than about 0.2 MPa. The person skilled in the art would also readily appreciate that a suitable pressure for the method for preparing particles comprising MnO₂ of the present disclosure would be selected such that the reaction conditions would not involve pressures that are unsuitably low such as high vacuum conditions. In an embodiment, the reaction is carried out at ambient pressure or a near-ambient pressure, e.g., a pressure that is within about ±10% or about ±5% of ambient pressure. In an embodiment, the reaction is carried out at ambient pressure. The method for preparing particles comprising MnO₂ of the present disclosure can advantageously be carried out without means for increasing and/or reducing pressure and vessels constructed to withstand such increases and/or reductions in pressure such as an autoclave used for the high-pressure conditions of hydrothermal synthesis. Accordingly, in an embodiment, the reaction is carried out in a vessel which is open to or otherwise substantially in equilibrium with the surrounding environment in such a way that the pressure inside the vessel is not significantly different from the ambient pressure in the surrounding environment. A person skilled in the art would readily appreciate that ambient pressure may depend, for example, on the elevation at which the reaction is carried out. In an embodiment, the reaction is carried out at a pressure that is from about 45 kPa to about 110 kPa.

The manganese (II) salt can be any suitable manganese (II) salt or combination thereof. For example, in some embodiments, the manganese (II) salt is desirably selected such that the reaction of the manganese (II) salt with the oxidizing agent generates an acid to provide acidic conditions useful in producing the particles comprising MnO₂. In some embodiments, a suitable acid (e.g., H₂SO₄) is added to the reaction. For example, it would be appreciated by a person skilled in the art that a suitable acid would not participate in the reaction so as to alter the chemistry of the final products. In an embodiment, the manganese (II) salt comprises, consists essentially of or consists of MnCl₂, MnSO₄, MnSO₃ or combinations thereof. In an embodiment, the manganese (II) salt comprises MnSO₄. In another embodiment, the manganese (II) salt consists essentially of MnSO₄. In a further embodiment, the manganese (II) salt consists of MnSO₄. In an embodiment, the manganese (II) salt (e.g., the MnSO₄) is added to the aqueous environment in the form of a hydrate. In an embodiment, the hydrated form of MnSO₄ is MnSO₄·H₂O.

The oxidizing agent can be any suitable oxidizing agent or combination thereof. In an embodiment, the oxidizing agent is a persulfate (e.g., ammonium persulfate, sodium persulfate and/or potassium persulfate), a permanganate (e.g., sodium permanganate and/or potassium permanganate), permanganic acid, a perchlorate (e.g., sodium perchlorate) or suitable combinations thereof. In an embodiment, the oxidizing agent is a persulfate. In an embodiment, the oxidizing agent comprises, consists essentially of or consists of (NH₄)₂S₂O₈, Na₂S₂O₈, K₂S₂O₈, NaMnO₄, KMnO₄, HMnO₄ or NaClO. In another embodiment, the oxidizing agent comprises (NH₄)₂S₂O₈. In another embodiment, the oxidizing agent consists essentially of (NH₄)₂S₂O₈. In a further embodiment, the oxidizing agent consists of (NH₄)₂S₂O₈.

In an embodiment, the concentration of the manganese (II) salt in the aqueous environment is from about 0.05 M to about 0.5 M, from about 0.1 M to about 0.33 M, about 0.1 M or about 0.33 M. In an embodiment, the concentration of the oxidizing agent in the aqueous environment is from about 0.05 M to about 0.5 M, from about 0.1 M to about 0.33 M, about 0.1 M or about 0.33 M. It will be appreciated by a person skilled in the art that the molar ratio between the manganese (II) salt and the oxidizing agent may vary, for example, according to the identity of the manganese (II) salt and the oxidizing agent. For example, in embodiments wherein the manganese (II) salt is MnSO₄ or MnSO₃ and the oxidizing agent is a persulfate (e.g., (NH₄)₂S₂O₈), the molar ratio of the manganese (II) salt to the oxidizing agent can be about 1:1. In another embodiment, the manganese (II) salt is MnCl₂ and the oxidizing agent is a persulfate (e.g., (NH₄)₂S₂O₈), and the molar ratio of the manganese (II) salt to the oxidizing agent can be about 1:4.

In some embodiments, the method comprises adding the oxidizing agent to an aqueous solution comprising the manganese (II) salt. In some embodiments, the method comprises mixing (e.g., agitating) the manganese (II) salt and the oxidizing agent at ambient temperature (e.g., a temperature of about 4° C. to about 40° C. or about 25° C.) prior to reacting the manganese (II) salt and the oxidizing agent at the temperature, e.g., of from about 40° C. to about 100° C.

In an embodiment, the reaction is carried out at a temperature of from about 50° C. to about 100° C. In an embodiment, the reaction is carried out at a temperature of from about 60° C. to about 100° C. In another embodiment, the reaction is carried out at a temperature of from about 70° C. to about 100° C. In another embodiment, the reaction is carried out at a temperature of from about 80° C. to about 90° C. In a further embodiment, the reaction is carried out at a temperature of about 80° C. In another embodiment, the reaction is carried out at a temperature of about 90° C. In an embodiment, the temperature is maintained substantially constant during the reaction.

In an embodiment, the reaction is carried out for a time of about 1 hour to about 40 hours. In another embodiment, the reaction is carried out for a time of about 2 hours to about 6 hours. In a further embodiment, the reaction is carried out for a time of about 3 hours to about 4 hours. In another embodiment, the reaction is carried out for a time of about 3 hours. In a further embodiment, the reaction is carried out for a time of about 4 hours. In another embodiment of the present disclosure, the reaction is carried out for a time of about 5 hours.

In an embodiment, pH of the mixture after reaction is about 1 or less.

In an embodiment, the method comprises agitation during the reaction. The agitation can be carried out by any suitable method and/or means, the selection of which can be readily made by a person skilled in the art. In an embodiment, the agitation comprises stirring.

In an embodiment, the method further comprises separating the particles comprising the MnO₂ from the aqueous environment. The separation can be carried out by any suitable method and/or means, the selection of which can be readily made by a person skilled in the art. For example, in an embodiment, the separation comprises filtration, centrifugation or combinations thereof. In another embodiment, the separation comprises centrifugation. In an embodiment, the method further comprises cooling the reaction prior to separation. For example, in an embodiment, the method comprises allowing the reaction to cool for a time of about 1 hour to about 6 hours or about 2 hours until reaching ambient temperature (e.g., about 4° C. to about 40° C. or about 25° C.).

In an embodiment, the method further comprises washing the separated particles comprising the MnO₂. The washing can comprise any suitable method and/or means, the selection of which can be readily made by a person skilled in the art. For example, in an embodiment, the washing comprises washing with a suitable organic solvent or mixtures thereof (e.g., washing with ethanol) and then washing with water (e.g., distilled or deionized water) until the water which has been contacted with the particles has a pH of about 7.

In an embodiment, the method further comprises drying the separated and optionally washed particles comprising the MnO₂. The drying can comprise any suitable method and/or means, the selection of which can be readily made by a person skilled in the art. In an embodiment, the drying comprises applying heat to the separated and optionally washed particles comprising the MnO₂ at a temperature and for a time suitable to remove a desired amount of moisture from the particles comprising the MnO₂. In an embodiment, the particles comprising the MnO₂ are dried at a temperature of from about 40° C. to about 150° C., about 60° C. to about 100° C., about 70° C. or about 90° C. In an embodiment, the drying is for a time of about 2 hours to about 24 hours, about 6 hours to about 10 hours or about 8 hours.

In some embodiments, the reacting of the manganese (II) salt with the oxidizing agent in the aqueous environment is in an aqueous environment consisting of or consisting essentially of water, the manganese (II) salt and the oxidizing agent as starting reagents.

In other embodiments, the reacting of the manganese (II) salt with an oxidizing agent in the aqueous environment is in an aqueous environment comprising water, the manganese (II) salt and the oxidizing agent as starting reagents. For example, in some embodiments, the method further comprises reacting the manganese (II) salt with the oxidizing agent in the presence of a carbon-based material to obtain the particles comprising MnO₂ in the form of a composite comprising the MnO₂ deposited on the surface of the carbon-based material. The carbon-based material can be any suitable carbon-based material, the selection of which can be readily made by a person skilled in the art. In an embodiment, the carbon-based material is selected from graphene, carbon nanofibers (CNF), carbon nanotubes (CNT), carbon black (CB) and mixtures thereof. In another embodiment, the carbon-based material comprises, consists essentially of or consists of carbon nanofibers. In an embodiment, the manganese (II) salt is reacted with the oxidizing agent in the presence of from about 0.01 wt. % to about 1 wt. %, about 0.1 wt. % to about 0.5 wt. % or about 0.25 wt. % of the carbon-based material, based on the total amount of the MnO₂ prepared from the reaction.

The present disclosure also includes a particle comprising MnO₂ prepared by a method for preparing particles comprising MnO₂ as described herein.

The present disclosure also includes a particle comprising MnO₂, wherein the particle is substantially spherical and comprises rod-like extensions with flat ends radiating outwardly from the center of the particle. In an embodiment, the rod-like extensions have an average length of about 200 nm to about 500 nm and an average width of about 20 nm to about 50 nm. In an embodiment of the present disclosure, the particle comprising MnO₂ is prepared by a method for preparing particles comprising MnO₂ as described herein.

In an embodiment, the average diameter of the particle comprising MnO₂ is from about 1.5 μm to about 4 μm. In another embodiment, the average diameter of the particle comprising MnO₂ is from about 2 μm to about 3 μm. In an embodiment, the Brunauer-Emmett-Teller (B.E.T.) surface area of the particle is from about 35 m²/g to about 100 m²/g. In another embodiment, the B.E.T. surface area of the particle is from about 35 m²/g to about 65 m²/g. In a further embodiment, the B.E.T. surface area of the particle is from about 40 m²/g to about 55 m²/g. In an embodiment, the total pore volume of the particle is from about 0.1 cm³/g to about 0.2 cm³/g or about 0.18 cm³/g.

In an embodiment, the MnO₂ comprises, consists essentially of or consists of γ-MnO₂.

The present disclosure also includes a cathode comprising a particle comprising MnO₂ as described herein and/or prepared by a method for preparing particles comprising MnO₂ as described herein. The present disclosure also includes an electrochemical cell comprising such a cathode. The present disclosure also includes an electrochemical cell comprising a particle comprising MnO₂ as described herein and/or prepared by a method for preparing particles comprising MnO₂ as described herein. In an embodiment, the electrochemical cell is a rechargeable electrochemical cell. In another embodiment, the electrochemical cell comprises an anode comprising zinc. In a further embodiment, the electrochemical cell comprises an aqueous electrolyte. In an embodiment, the aqueous electrolyte comprises a zinc salt and optionally a manganese salt, an alkali metal salt, an alkaline earth metal salt or combinations thereof. In another embodiment, the zinc salt is zinc sulfate. In another embodiment, the manganese salt is manganese (II) sulfate. In an embodiment, the alkali metal salt is an alkali metal sulfate. In an embodiment, the alkali metal sulfate is lithium sulfate, potassium sulfate or combinations thereof. In a further embodiment, the alkaline earth metal salt is magnesium sulfate. In an embodiment, the aqueous electrolyte comprises zinc sulfate, manganese (II) sulfate and magnesium sulfate. The embodiments of such an electrochemical cell may also be suitably varied as described herein for other embodiments of rechargeable electrochemical cells of the present disclosure.

The present disclosure also includes a rechargeable electrochemical cell, comprising:
a cathode comprising a particle comprising MnO₂ as described herein and/or prepared by a method for preparing particles comprising MnO₂ as described herein;
an anode comprising zinc; and
an aqueous electrolyte comprising a zinc salt and optionally a manganese salt, wherein the aqueous electrolyte has a pH of from about 3 to about 7.

In an embodiment, the rechargeable electrochemical cell further comprises a separator separating the cathode and the anode. The material for the separator can be any suitable material. In an embodiment, the separator comprises, consists essentially of or consists of glass fibers.

In an embodiment, the aqueous electrolyte has a pH of from about 3.8 to about 5. In another embodiment, the aqueous electrolyte has a pH of from about 3.9 to about 4.3.

The zinc salt can be any suitable zinc salt or combination thereof. In an embodiment, the zinc salt is zinc sulfate. In an embodiment, the aqueous electrolyte comprises the manganese salt. The manganese salt can be any suitable manganese salt or combination thereof. In an embodiment, the manganese salt is manganese (II) sulfate. In an embodiment, the zinc salt is zinc sulfate and the aqueous electrolyte comprises the manganese salt, wherein the manganese salt is manganese (II) sulfate. The concentration of the zinc salt e.g., the zinc sulfate and the manganese salt e.g., the manganese (II) sulfate (if present) in the electrolyte is any suitable concentration. In an embodiment, the concentration of the zinc salt in the electrolyte is from about 0.5 M to about 2 M, about 1 M to about 2 M or about 1 M. In another embodiment, the concentration of the manganese salt in the electrolyte is from about 0.01 to about 0.2 M, about 0.05 to about 0.15 M or about 0.1 M.

In an embodiment, the aqueous electrolyte further comprises an alkali metal salt, an alkaline earth metal salt, an anionic surfactant, ethylene glycol, silicon dioxide or combinations thereof. In an embodiment, the aqueous electrolyte further comprises the alkali metal salt. In another embodiment, the aqueous electrolyte further comprises the alkaline earth metal salt. In another embodiment, the aqueous electrolyte further comprises the anionic surfactant. In another embodiment, the aqueous electrolyte further comprises the ethylene glycol. In another embodiment, the aqueous electrolyte further comprises the silicon dioxide. In another embodiment, the aqueous electrolyte further comprises any combination of the alkali metal salt, alkaline earth metal salt, anionic surfactant, ethylene glycol and silicon dioxide.

The alkali metal salt can be any suitable alkali metal salt or combination thereof. In an embodiment, the alkali metal salt is an alkali metal sulfate. In an embodiment, the alkali metal salt comprises, consists essentially of or consists of lithium sulfate, potassium sulfate or combinations thereof. In another embodiment, the alkali metal salt comprises, consists essentially of or consists of lithium sulfate. In a further embodiment, the alkali metal salt comprises, consists essentially of or consists of potassium sulfate. The concentration of the alkali metal salt (if present) in the aqueous electrolyte is any suitable concentration. In an embodiment, the concentration of the alkali metal salt in the aqueous electrolyte is from about 0.1 M to about 1 M, about 0.2 M to about 0.3 M, about 0.25 M to about 0.75 M, about 0.5 M or about 0.25 M.

The alkaline earth metal salt can be any suitable alkaline earth metal salt or combination thereof. In an embodiment, the alkaline earth metal salt comprises, consists essentially of or consists of magnesium sulfate. The concentration of the alkaline earth metal salt (if present) in the aqueous electrolyte is any suitable concentration. In an embodiment, the concentration of the alkaline earth metal salt in the aqueous electrolyte is from about 0.1 M to about 1 M, about 0.25 M to about 0.75 M or about 0.5 M. In an embodiment, the aqueous electrolyte comprises zinc sulfate, manganese (II) sulfate and magnesium sulfate. In another embodiment, the aqueous electrolyte comprises about 1 M zinc sulfate, about 0.1 M manganese (II) sulfate and about 0.5 M magnesium sulfate.

The concentration of the ethylene glycol (if present) in the aqueous electrolyte is any suitable concentration. In an embodiment, the concentration of the ethylene glycol in the aqueous electrolyte is from about 0.05 vol % to about 5 vol %, about 0.1 vol % to about 1 vol % or about 0.5 vol %. In an embodiment, the aqueous electrolyte comprises zinc sulfate, manganese (II) sulfate and ethylene glycol. In another embodiment, the aqueous electrolyte comprises zinc sulfate, manganese (II) sulfate, an alkaline earth metal salt (e.g., magnesium sulfate) and ethylene glycol.

In an embodiment, the aqueous electrolyte further comprises a secondary organic additive agent. The secondary organic additive agent can be any suitable secondary organic additive agent or mixture thereof. It will be appreciated a person skilled in the art that the secondary organic additive agent is desirably mixed with a solubilizing agent for the secondary organic additive prior to addition to the aqueous electrolyte. The solubilizing agent can be any suitable solubilizing agent. For example, it would be appreciated by a person skilled in the art that a suitable solubilizing agent may be an organic compound comprising polar functional groups. In an embodiment, the solubilizing agent is ethylene glycol. For example, in an embodiment, the aqueous electrolyte comprises ethylene glycol and the ethylene glycol is mixed with the secondary organic additive agent. In an embodiment, the secondary organic additive agent is selected from salicylaldehyde (SAL), benzylideneacetone (BDA), benzylacetone (BA), butylbenzene (BB) and combinations thereof. In another embodiment, the aqueous electrolyte comprises at least 0.5 vol % of the solubilizing agent mixed with a secondary organic additive agent selected from salicylaldehyde (SAL), benzylideneacetone (BDA), benzylacetone (BA), butylbenzene (BB) and combinations thereof. In another embodiment, the aqueous electrolyte comprises at least 0.5 vol % ethylene glycol mixed with a secondary organic additive agent selected from salicylaldehyde (SAL), benzylideneacetone (BDA), benzylacetone (BA), butylbenzene (BB) and combinations thereof.

The anionic surfactant can be any suitable anionic surfactant or combination thereof. In an embodiment, the anionic surfactant comprises magnesium lauryl sulfate, potassium lauryl sulfate, lithium lauryl sulfate, sodium dodecyl sulfate, sodium dodecyl benzene sulfonate or combinations thereof. In an embodiment, the anionic functional group of the anionic surfactant is a sulfate. In an embodiment, the anionic surfactant does not comprise sodium dodecyl sulfate. In another embodiment, the anionic surfactant is potassium lauryl sulfate, magnesium lauryl sulfate, lithium lauryl sulfate or combinations thereof. In another embodiment, the anionic surfactant is magnesium lauryl sulfate. In an embodiment, the cation of the anionic surfactant is the same as the cation of the alkali metal salt or alkaline earth metal salt, as the case may be. The concentration of the anionic surfactant (if present) in the aqueous electrolyte is any suitable concentration. In an embodiment, the concentration of the anionic surfactant in the aqueous electrolyte is from about 0.1 mM to about 1 mM, about 0.25 mM to about 0.75 mM or about 0.5 mM. In an embodiment, the aqueous electrolyte comprises zinc sulfate, manganese (II) sulfate and the anionic surfactant (e.g., magnesium lauryl sulfate). In another embodiment, the aqueous electrolyte comprises zinc sulfate, manganese (II) sulfate, an alkaline earth metal salt (e.g., magnesium sulfate) and the anionic surfactant (e.g., magnesium lauryl sulfate). In an embodiment, the aqueous electrolyte comprises zinc sulfate, manganese (II) sulfate, magnesium sulfate and magnesium lauryl sulfate. In another embodiment, the aqueous electrolyte comprises zinc sulfate, manganese (II) sulfate, an alkali metal sulfate (e.g., lithium sulfate) and the anionic surfactant (e.g., magnesium lauryl sulfate).

The silicon dioxide can be any suitable form of silicon dioxide or combinations thereof. In an embodiment, the silicon dioxide is in the form of hygroscopic fumed silica particles. The concentration of the silicon dioxide (if present) in the aqueous electrolyte is any suitable concentration. In an embodiment, the concentration of the silicon dioxide in the aqueous electrolyte is from about 1 wt. % to about 20 wt. %, about 5 wt. % to about 15 wt. % or about 10 wt. %. In an embodiment, the aqueous electrolyte comprises zinc sulfate, manganese (II) sulfate, an alkaline earth metal salt (e.g., magnesium sulfate) and the silicon dioxide.

It will be appreciated by a person skilled in the art that the cathode comprising or consisting essentially of the particle comprising MnO₂ as described herein and/or prepared by a method for preparing particles comprising MnO₂ as described herein can optionally comprise other materials commonly used in cathodes for such rechargeable electrochemical cells. For example, in some embodiments, the cathode can optionally further include a suitable binder, electrically conductive material or combinations thereof. The binder can be any suitable binder. For example, it will be appreciated by a person skilled in the art that a suitable binder is desirably inert (e.g., at least substantially, optionally fully non-reactive to the other components in the rechargeable electrochemical cell). In an embodiment, the binder is a polyvinylidene fluoride. In another embodiment, the polyvinylidene fluoride has an Mw of about 400,000 to about 600,000 or about 534,000. The electrically conductive material can be any suitable electrically conductive material. In an embodiment, the electrically conductive material is carbon black. In an embodiment, the cathode is prepared by a method comprising the use of a suitable solvent. In an embodiment, the solvent is 1-methyl-2-pyrrolidinone. In an embodiment, the rechargeable electrochemical cell further comprises a cathode current collector. In another embodiment, the cathode is deposited on a carbon-based current collector. The carbon-based current collector can be any suitable carbon-based current collector. In an embodiment, the carbon-based current collector comprises, consists essentially of or consists of graphite foil, carbon fiber paper, carbon cloth, carbon mesh or combinations thereof. In an embodiment, the cathode comprises from about 70 wt. % to about 90 wt. %, about 80 wt. % or about 82 wt. % of the particles comprising MnO₂, about 5 wt. % to about 15 wt. % or about 10 wt. % binder (e.g., polyvinylidene fluoride) and about 5 wt. % to about 15 wt. %, about 10 wt. % or about 8 wt. % of the electrically conductive material (e.g., carbon black) optionally deposited on the carbon-based current collector. In an embodiment, the cathode comprises about 80 wt. % of the particles comprising MnO₂, about 10 wt. % binder (e.g., polyvinylidene fluoride) and about 10 wt. % of the electrically conductive material (e.g., carbon black) optionally deposited on the carbon-based current collector. It will be appreciated by a person skilled in the art that the relative amounts of particles comprising MnO₂, binder and electrically conductive material used may vary, for example, based on the morphology and/or size of the particles comprising MnO₂ and whether the particles comprising MnO₂ are in the form of a composite comprising the MnO₂ deposited on the surface of a carbon-based material as described herein. For example, typically if lower than about 80 wt. % of particles comprising MnO₂ is used, a greater percentage by weight of the electrically conductive material is used (e.g., about 75 wt. % of the particles comprising MnO₂, about 10 wt. % binder (e.g., polyvinylidene fluoride) and about 15 wt. % of the electrically conductive material (e.g., carbon black)) and if greater than about 80 wt % of particles comprising MnO₂ is used, a lower percentage by weight of the binder is used (e.g., about 82 wt. % of the particles comprising MnO₂, about 8 wt. % binder (e.g., polyvinylidene fluoride) and about 10 wt. % of the electrically conductive material (e.g., carbon black)). However, it will also be appreciated by a person skilled in the art that cathodes comprising composites comprising the MnO₂ deposited on the surface of a carbon-based material as described herein may, for example, comprise a greater percentage by weight of the particles comprising the MnO₂ (e.g., about 82 wt. %) and a lower percentage by weight of the electrically conductive material (e.g., about 8 wt. %) in comparison to cathodes comprising particles comprising the MnO₂ that are not in the form of such composites.

The anode comprising zinc is any suitable anode comprising zinc. In an embodiment, the anode comprising zinc comprises, consists essentially of or consists of a zinc foil. In another embodiment, the zinc foil has a thickness of from about 30 μm to about 70 μm.

In an embodiment, the anode comprising zinc has been etched with acid. In an embodiment, the acid is an inorganic acid. In an embodiment, the acid comprises sulfuric acid or nitric acid. In another embodiment, the acid comprises, consists essentially of or consists of sulfuric acid. In another embodiment, the acid does not comprise HCl. In an embodiment, the anode comprising zinc has been etched with sulfuric acid. In another embodiment, the etching with sulfuric acid is for a time of about 30 seconds to about 90 seconds or about 1 minute with sulfuric acid having a concentration of about 1 M to about 5 M, about 2 M to about 4 M or about 3 M. In another embodiment, the etching with sulfuric acid is for a time of about 1 minute with sulfuric acid having a concentration of about 3 M. In an embodiment, the etching of the anode with the sulfuric acid is carried out at ambient temperature (e.g., a temperature of from about 4° C. to about 40° C. or about 25° C.).

In an embodiment, the electrochemical cell is a coin cell, a cylindrical cell, a pouch cell or a prismatic cell. In another embodiment, the electrochemical cell is a coin cell.

The present disclosure also includes a rechargeable electrochemical cell, comprising:
a cathode;
an anode comprising zinc; and
an aqueous electrolyte comprising a zinc salt, a manganese salt, and an alkali metal salt, an alkaline earth metal salt or combinations thereof, wherein the aqueous electrolyte has a pH of from about 3 to about 7.

In an embodiment, the rechargeable electrochemical cell further comprises a separator separating the cathode and the anode. The material for the separator can be any suitable material. In an embodiment, the separator comprises, consists essentially of or consists of glass fibers.

In an embodiment, the aqueous electrolyte has a pH of from about 3.8 to about 5. In another embodiment, the aqueous electrolyte has a pH of from about 3.9 to about 4.3.

The zinc salt can be any suitable zinc salt or combination thereof. In an embodiment, the zinc salt is zinc sulfate. The manganese salt can be any suitable manganese salt or combination thereof. In an embodiment, the manganese salt is manganese (II) sulfate. The concentration of the zinc salt (e.g., the zinc sulfate) and the manganese salt (e.g., the manganese (II) sulfate) in the electrolyte is any suitable concentration. In an embodiment, the concentration of the zinc salt in the electrolyte is from about 0.5 M to about 2 M, about 1 M to about 2 M or about 1 M. In another embodiment, the concentration of the manganese salt in the electrolyte is from about 0.01 to about 0.2 M, about 0.05 to about 0.15 M or about 0.1 M.

In an embodiment, the aqueous electrolyte comprises the alkali metal salt. The alkali metal salt can be any suitable alkali metal salt or combination thereof. In an embodiment, the alkali metal salt is an alkali metal sulfate. In an embodiment, the alkali metal salt comprises, consists essentially of or consists of lithium sulfate, potassium sulfate or combinations thereof. In another embodiment, the alkali metal salt comprises, consists essentially of or consists of lithium sulfate. In a further embodiment, the alkali metal salt comprises, consists essentially of or consists of potassium sulfate. The concentration of the alkali metal salt (if present) in the aqueous electrolyte is any suitable concentration. In an embodiment, the concentration of the alkali metal salt in the aqueous electrolyte is from about 0.1 M to about 1 M, about 0.2 M to about 0.3 M, about 0.25 M to about 0.75 M, about 0.5 M or about 0.25 M.

In an embodiment, the aqueous electrolyte comprises the alkaline earth metal salt. The alkaline earth metal salt can be any suitable alkaline earth metal salt or combination thereof. In an embodiment, the alkaline earth metal salt comprises, consists essentially of or consists of magnesium sulfate. The concentration of the alkaline earth metal salt (if present) in the aqueous electrolyte is any suitable concentration. In an embodiment, the concentration of the alkaline earth metal salt in the aqueous electrolyte is from about 0.1 M to about 1 M, about 0.25 M to about 0.75 M or about 0.5 M. In an embodiment, the aqueous electrolyte comprises zinc sulfate, manganese (II) sulfate and magnesium sulfate. In another embodiment, the aqueous electrolyte comprises about 1 M zinc sulfate, about 0.1 M manganese (II) sulfate and about 0.5 M magnesium sulfate.

In an embodiment, the aqueous electrolyte further comprises an anionic surfactant, ethylene glycol, silicon dioxide or combinations thereof. In another embodiment, the aqueous electrolyte further comprises the anionic surfactant. In another embodiment, the aqueous electrolyte further comprises the ethylene glycol. In another embodiment, the aqueous electrolyte further comprises the silicon dioxide. In another embodiment, the aqueous electrolyte further comprises any combination of the anionic surfactant, ethylene glycol and silicon dioxide.

The concentration of the ethylene glycol (if present) in the aqueous electrolyte is any suitable concentration. In an embodiment, the concentration of the ethylene glycol in the aqueous electrolyte is from about 0.05 vol % to about 5 vol %, about 0.1 vol % to about 1 vol % or about 0.5 vol %. In an embodiment, the aqueous electrolyte comprises zinc sulfate, manganese (II) sulfate and ethylene glycol. In another embodiment, the aqueous electrolyte comprises zinc sulfate, manganese (II) sulfate, an alkaline earth metal salt (e.g., magnesium sulfate) and ethylene glycol.

In an embodiment, the aqueous electrolyte further comprises a secondary organic additive agent. The secondary organic additive agent can be any suitable secondary organic additive agent or mixture thereof. It will be appreciated a person skilled in the art that the secondary organic additive agent is desirably mixed with a solubilizing agent for the secondary organic additive prior to addition to the aqueous electrolyte. The solubilizing agent can be any suitable solubilizing agent. For example, it would be appreciated by a person skilled in the art that a suitable solubilizing agent may be an organic compound comprising polar functional groups. In an embodiment, the solubilizing agent is ethylene glycol. For example, in an embodiment, the aqueous electrolyte comprises ethylene glycol and the ethylene glycol is mixed with the secondary organic additive agent. In an embodiment, the secondary organic additive agent is selected from salicylaldehyde (SAL), benzylideneacetone (BDA), benzylacetone (BA), butylbenzene (BB) and combinations thereof. In another embodiment, the aqueous electrolyte comprises at least 0.5 vol % of the solubilizing agent mixed with a secondary organic additive agent selected from salicylaldehyde (SAL), benzylideneacetone (BDA), benzylacetone (BA), butylbenzene (BB) and combinations thereof. In another embodiment, the aqueous electrolyte further comprises at least 0.5 vol % ethylene glycol mixed with a secondary organic additive agent selected from salicylaldehyde (SAL), benzylideneacetone (BDA), benzylacetone (BA), butylbenzene (BB) and combinations thereof.

The anionic surfactant can be any suitable anionic surfactant or combination thereof. In an embodiment, the anionic surfactant comprises magnesium lauryl sulfate, potassium lauryl sulfate, lithium lauryl sulfate, sodium dodecyl sulfate, sodium dodecyl benzene sulfonate or combinations thereof. In an embodiment, the hydrophilic head group of the anionic surfactant is a sulfate. In an embodiment, the anionic surfactant does not comprise sodium dodecyl sulfate. In another embodiment, the anionic surfactant is potassium lauryl sulfate, magnesium lauryl sulfate, lithium lauryl sulfate or combinations thereof. In another embodiment, the anionic surfactant is magnesium lauryl sulfate. In an embodiment, the cation of the anionic surfactant is the same as the cation of the alkali metal salt or alkaline earth metal salt, as the case may be. The concentration of the anionic surfactant (if present) in the aqueous electrolyte is any suitable concentration. In an embodiment, the concentration of the anionic surfactant in the aqueous electrolyte is from about 0.1 mM to about 1 mM, about 0.25 mM to about 0.75 mM or about 0.5 mM. In an embodiment, the aqueous electrolyte comprises zinc sulfate, manganese (II) sulfate and the anionic surfactant (e.g., magnesium lauryl sulfate). In another embodiment, the aqueous electrolyte comprises zinc sulfate, manganese (II) sulfate, an alkaline earth metal salt (e.g., magnesium sulfate) and the anionic surfactant (e.g., magnesium lauryl sulfate). In an embodiment, the aqueous electrolyte comprises zinc sulfate, manganese (II) sulfate, magnesium sulfate and magnesium lauryl sulfate. In another embodiment, the aqueous electrolyte comprises zinc sulfate, manganese (II) sulfate, an alkali metal sulfate (e.g., lithium sulfate) and the anionic surfactant (e.g., magnesium lauryl sulfate).

The silicon dioxide can be any suitable form of silicon dioxide or combinations thereof. In an embodiment, the silicon dioxide is in the form of hygroscopic fumed silica particles. The concentration of the silicon dioxide (if present) in the aqueous electrolyte is any suitable concentration. In an embodiment, the concentration of the silicon dioxide in the aqueous electrolyte is from about 1 wt. % to about 20 wt. %, about 5 wt. % to about 15 wt. % or about 10 wt. %. In an embodiment, the aqueous electrolyte comprises zinc sulfate, manganese (II) sulfate, an alkaline earth metal salt (e.g., magnesium sulfate) and the silicon dioxide.

The cathode can comprise any active material suitable for use in a rechargeable electrochemical cell comprising an anode comprising zinc and an aqueous electrolyte comprising a zinc salt and a manganese salt. In an embodiment, the cathode comprises, consists essentially of or consists of manganese oxide (MnₓO_{y}), a zinc manganese oxide, a manganese-zinc hydrated sulfate hydroxide, a zinc hydroxide sulfate hydrate or combinations thereof. In an embodiment, the zinc hydroxide sulfate hydrate has the formula Zn₄(OH)₆(SO₄)·nH₂O, wherein n=0, 0.5, 1, 3, 4 or 5. In an embodiment, the cathode comprises, consists essentially of or consists of manganese oxide. In another embodiment, the cathode comprises, consists essentially of or consists of MnO₂. In an embodiment, the MnO₂ is undoped MnO₂. In an embodiment, the MnO₂ comprises γ-MnO₂. In an embodiment, the MnO₂ comprises MnO₂ particles having a hierarchical structure. In an embodiment, the particles having a hierarchical structure are prepared by a method comprising reaction of a manganese (II) salt with an oxidizing agent in an aqueous environment. In an embodiment, the reaction comprises a hydrothermal reaction of the manganese (II) salt with the oxidizing agent. In another embodiment, the MnO₂ particles having a hierarchical structure are a particle comprising MnO₂ of the present disclosure and/or prepared by a method for preparing particles comprising MnO₂ as described herein. It will also be appreciated by a person skilled in the art that in use, an electrochemical cell comprising a cathode comprising, consisting essentially of or consisting of a manganese oxide and an anode comprising zinc may produce other forms of materials such as manganese-zinc hydrated sulfate hydroxide (MnₓZn_{y}(OH)_{z}SO₄·5H₂O) and/or ZnₓMn_{y}O_{z} accordingly, such materials are also optionally contemplated in such cathodes of the present disclosure comprising, or consisting essentially of a manganese oxide. In an embodiment, the cathode, when used, comprises a lower amount of such other forms of materials in comparison to a similar cell which comprises an aqueous electrolyte comprising a zinc salt and a manganese salt but not the alkali metal salt, alkaline earth metal salt or combinations thereof.

It will be appreciated by a person skilled in the art that the cathode can optionally comprise other materials commonly used in cathodes for such rechargeable electrochemical cells. For example, in some embodiments, the cathode can optionally further include a suitable binder, electrically conductive material or combinations thereof. The binder can be any suitable binder. For example, it will be appreciated by a person skilled in the art that a suitable binder is desirably inert (e.g., at least substantially, optionally fully non-reactive to the other components in the rechargeable electrochemical cell). In an embodiment, the binder is a polyvinylidene fluoride. In another embodiment, the polyvinylidene fluoride has an Mw of about 400,000 to about 600,000 or about 534,000. The electrically conductive material can be any suitable electrically conductive material. In an embodiment, the electrically conductive material is carbon black. In an embodiment, the cathode is prepared by a method comprising the use of a suitable solvent. In an embodiment, the solvent is 1-methyl-2-pyrrolidinone. In an embodiment, the rechargeable electrochemical cell further comprises a cathode current collector. In another embodiment, the cathode is deposited on a carbon-based current collector. The carbon-based current collector can be any suitable carbon-based current collector. In an embodiment, the carbon-based current collector comprises, consists essentially of or consists of graphite foil, carbon fiber paper, carbon cloth, carbon mesh or combinations thereof. In an embodiment, the cathode comprises from about 70 wt. % to about 90 wt. %, or about 80 wt. % of the active material such as manganese oxide (e.g., MnO₂), about 5 wt. % to about 15 wt. % or about 10 wt. % binder (e.g., polyvinylidene fluoride) and about 5 wt. % to about 15 wt. %, or about 10 wt. % of the electrically conductive material (e.g., carbon black) optionally deposited on the carbon-based current collector. In an embodiment, the cathode comprises about 80 wt. % of the active material such as manganese oxide (e.g., MnO₂), about 10 wt. % binder (e.g., polyvinylidene fluoride) and about 10 wt. % of the electrically conductive material (e.g., carbon black) optionally deposited on the carbon-based current collector. It will be appreciated by a person skilled in the art that the relative amounts of active material, binder and electrically conductive material used may vary, for example, based on the identity, morphology and/or size of particles of the active material and whether the cathode comprises the MnO₂ deposited on the surface of a carbon-based material as described herein. For example, in the case of a cathode with particles comprising MnO₂ typically if lower than about 80 wt % of particles comprising MnO₂ is used, a greater percentage by weight of the electrically conductive material is used (e.g., about 75 wt. % of the particles comprising MnO₂, about 10 wt. % binder (e.g., polyvinylidene fluoride) and about 15 wt. % of the electrically conductive material (e.g., carbon black)) and if greater than about 80 wt % of particles comprising MnO₂ is used, a lower percentage by weight of the binder is used (e.g., about 82 wt. % of the particles comprising MnO₂, about 8 wt. % binder (e.g., polyvinylidene fluoride) and about 10 wt. % of the electrically conductive material (e.g., carbon black)). However, it will also be appreciated by a person skilled in the art that cathodes comprising composites comprising the MnO₂ deposited on the surface of a carbon-based material as described herein may, for example, comprise a greater percentage by weight of the particles comprising the MnO₂ (e.g., about 82 wt. %) and a lower percentage by weight of the electrically conductive material (e.g., about 8 wt. %).

The anode comprising zinc is any suitable anode comprising zinc. In an embodiment, the anode comprising zinc comprises, consists essentially of or consists of a zinc foil. In another embodiment, the zinc foil has a thickness of from about 30 μm to about 70 μm.

In an embodiment, the anode comprising zinc has been etched with acid. In an embodiment, the acid is an inorganic acid. In an embodiment, the acid comprises sulfuric acid or nitric acid. In another embodiment, the acid comprises, consists essentially of or consists of sulfuric acid. In another embodiment, the acid does not comprise HCl. In an embodiment, the anode comprising zinc has been etched with sulfuric acid. In another embodiment, the etching with sulfuric acid is for a time of about 30 seconds to about 90 seconds or about 1 minute with sulfuric acid having a concentration of about 1 M to about 5 M, about 2 M to about 4 M or about 3 M. In another embodiment, the etching with sulfuric acid is for a time of about 1 minute with sulfuric acid having a concentration of about 3 M. In an embodiment, the etching of the anode with the sulfuric acid is carried out at ambient temperature (e.g., a temperature of from about 4° C. to about 40° C. or about 25° C.).

In an embodiment, the electrochemical cell is a coin cell, a cylindrical cell, a pouch cell or a prismatic cell. In another embodiment, the electrochemical cell is a coin cell.

The present disclosure also includes a rechargeable electrochemical cell, comprising:
a cathode;
an anode comprising zinc; and
an aqueous electrolyte comprising:
   a zinc salt;
   a lithium salt of an anionic surfactant, a potassium salt of an anionic surfactant, a magnesium salt of an anionic surfactant or combinations thereof; and
   optionally a manganese salt, an alkali metal salt, an alkaline earth metal salt or combinations thereof,
wherein the aqueous electrolyte has a pH of from about 3 to about 7.

In an embodiment, the rechargeable electrochemical cell further comprises a separator separating the cathode and the anode. The material for the separator can be any suitable material. In an embodiment, the separator comprises, consists essentially of or consists of glass fibers.

In an embodiment, the aqueous electrolyte has a pH of from about 3.8 to about 5. In another embodiment, the aqueous electrolyte has a pH of from about 3.9 to about 4.3.

The zinc salt can be any suitable zinc salt or combination thereof. In an embodiment, the zinc salt is zinc sulfate. In an embodiment, the aqueous electrolyte comprises the manganese salt. The manganese salt can be any suitable manganese salt or combination thereof. In an embodiment, the manganese salt is manganese (II) sulfate. In an embodiment, the zinc salt is zinc sulfate and the aqueous electrolyte comprises the manganese salt, wherein the manganese salt is manganese (II) sulfate. The concentration of the zinc salt e.g., the zinc sulfate and the manganese salt e.g., the manganese (II) sulfate (if present) in the electrolyte is any suitable concentration. In an embodiment, the concentration of the zinc salt in the electrolyte is from about 0.5 M to about 2 M, about 1 M to about 2 M or about 1 M. In another embodiment, the concentration of the manganese salt in the electrolyte is from about 0.01 to about 0.2 M, about 0.05 to about 0.15 M or about 0.1 M.

In an embodiment, the aqueous electrolyte further comprises the alkali metal salt, the alkaline earth metal salt or combinations thereof.

In an embodiment, the aqueous electrolyte comprises zinc sulfate, manganese (II) sulfate, and an alkali metal salt, an alkaline earth metal salt or combinations thereof.

In an embodiment, the aqueous electrolyte further comprises the alkali metal salt. The alkali metal salt can be any suitable alkali metal salt or combination thereof. In an embodiment, the alkali metal salt is an alkali metal sulfate. In an embodiment, the alkali metal sulfate comprises, consists essentially of or consists of lithium sulfate, potassium sulfate or combinations thereof. In another embodiment, the alkali metal salt comprises, consists essentially of or consists of lithium sulfate. In an embodiment, the alkali metal sulfate comprises, consists essentially of or consists of potassium sulfate. The concentration of the alkali metal salt (if present) in the aqueous electrolyte is any suitable concentration. In an embodiment, the concentration of the alkali metal salt in the aqueous electrolyte is from about 0.1 M to about 1 M, about 0.2 M to about 0.3 M, about 0.25 M to about 0.75 M, about 0.5 M or about 0.25 M.

In another embodiment, the aqueous electrolyte further comprises the alkaline earth metal salt. The alkaline earth metal salt can be any suitable alkaline earth metal salt or combination thereof. In an embodiment, the alkaline earth metal salt comprises, consists essentially of or consists of magnesium sulfate. The concentration of the alkaline earth metal salt (if present) in the aqueous electrolyte is any suitable concentration. In an embodiment, the concentration of the alkaline earth metal salt in the aqueous electrolyte is from about 0.1 M to about 1 M, about 0.25 M to about 0.75 M or about 0.5 M. In an embodiment, the aqueous electrolyte comprises zinc sulfate, manganese (II) sulfate and magnesium sulfate. In another embodiment, the aqueous electrolyte comprises about 1 M zinc sulfate, about 0.1 M manganese (II) sulfate and about 0.5 M magnesium sulfate.

In an embodiment, the aqueous electrolyte further comprises ethylene glycol, silicon dioxide or combinations thereof. In another embodiment, the aqueous electrolyte further comprises the ethylene glycol. In another embodiment, the aqueous electrolyte further comprises the silicon dioxide. In another embodiment, the aqueous electrolyte further comprises a combination of the ethylene glycol and silicon dioxide.

The concentration of the ethylene glycol (if present) in the aqueous electrolyte is any suitable concentration. In an embodiment, the concentration of the ethylene glycol in the aqueous electrolyte is from about 0.05 vol % to about 5 vol %, about 0.1 vol % to about 1 vol % or about 0.5 vol %.

In an embodiment, the aqueous electrolyte further comprises a secondary organic additive agent. The secondary organic additive agent can be any suitable secondary organic additive agent or mixture thereof. It will be appreciated a person skilled in the art that the secondary organic additive agent is desirably mixed with a solubilizing agent for the secondary organic additive prior to addition to the aqueous electrolyte. The solubilizing agent can be any suitable solubilizing agent. For example, it would be appreciated by a person skilled in the art that a suitable solubilizing agent may be an organic compound comprising polar functional groups. In an embodiment, the solubilizing agent is ethylene glycol. For example, in an embodiment, the aqueous electrolyte comprises ethylene glycol and the ethylene glycol is mixed with the secondary organic additive agent. In an embodiment, the secondary organic additive agent is selected from salicylaldehyde (SAL), benzylideneacetone (BDA), benzylacetone (BA), butylbenzene (BB) and combinations thereof. In another embodiment, the aqueous electrolyte comprises at least 0.5 vol % of the solubilizing agent mixed with a secondary organic additive agent selected from salicylaldehyde (SAL), benzylideneacetone (BDA), benzylacetone (BA), butylbenzene (BB) and combinations thereof. In another embodiment, the aqueous electrolyte comprises at least 0.5 vol % ethylene glycol mixed with a secondary organic additive agent selected from salicylaldehyde (SAL), benzylideneacetone (BDA), benzylacetone (BA), butylbenzene (BB) and combinations thereof.

The anionic surfactant can be any suitable anionic surfactant or combination thereof with a countercation that is a lithium ion, a potassium ion and/or a magnesium ion. In an embodiment, the anionic functional group of the anionic surfactant is a sulfate. In an embodiment, the anionic surfactant comprises magnesium lauryl sulfate, potassium lauryl sulfate, lithium lauryl sulfate or combinations thereof. In another embodiment, the anionic surfactant is potassium lauryl sulfate, magnesium lauryl sulfate, lithium lauryl sulfate or combinations thereof. In another embodiment, the anionic surfactant is magnesium lauryl sulfate. In an embodiment, the cation of the anionic surfactant is the same as the cation of the alkali metal salt or alkaline earth metal salt, as the case may be. The concentration of the anionic surfactant in the aqueous electrolyte is any suitable concentration. In an embodiment, the concentration of the anionic surfactant in the aqueous electrolyte is from about 0.1 mM to about 1 mM, about 0.25 mM to about 0.75 mM or about 0.5 mM. In an embodiment, the aqueous electrolyte comprises zinc sulfate, manganese (II) sulfate and the lithium salt of an anionic surfactant, potassium salt of an anionic surfactant, magnesium salt of an anionic surfactant or combinations thereof (e.g., magnesium lauryl sulfate). In another embodiment, the aqueous electrolyte comprises zinc sulfate, manganese (II) sulfate, an alkaline earth metal salt (e.g., magnesium sulfate) and the lithium salt of an anionic surfactant, potassium salt of an anionic surfactant, magnesium salt of an anionic surfactant or combinations thereof (e.g., magnesium lauryl sulfate). In an embodiment, the aqueous electrolyte comprises zinc sulfate, manganese (II) sulfate, magnesium sulfate and magnesium lauryl sulfate. In another embodiment, the aqueous electrolyte comprises zinc sulfate, manganese (II) sulfate, an alkali metal sulfate (e.g., lithium sulfate) and the anionic surfactant (e.g., magnesium lauryl sulfate).

The silicon dioxide can be any suitable form of silicon dioxide or combinations thereof. In an embodiment, the silicon dioxide is in the form of hygroscopic fumed silica particles. The concentration of the silicon dioxide (if present) in the aqueous electrolyte is any suitable concentration. In an embodiment, the concentration of the silicon dioxide in the aqueous electrolyte is from about 1 wt. % to about 20 wt. %, about 5 wt. % to about 15 wt. % or about 10 wt. %.

The cathode can comprise any active material suitable for use in a rechargeable electrochemical cell comprising an anode comprising zinc and an aqueous electrolyte comprising a zinc salt and optionally a manganese salt. In an embodiment, the cathode comprises, consists essentially of or consists of manganese oxide (MnₓO_{y}), a zinc manganese oxide, a manganese-zinc hydrated sulfate hydroxide, a zinc hydroxide sulfate hydrate or combinations thereof. In an embodiment, the zinc hydroxide sulfate hydrate has the formula Zn₄(OH)₆(SO₄)·nH₂O, wherein n=0, 0.5, 1, 3, 4 or 5. In an embodiment, the cathode comprises, consists essentially of or consists of manganese oxide. In another embodiment, the cathode comprises, consists essentially of or consists of MnO₂. In an embodiment, the MnO₂ is undoped MnO₂. In an embodiment, the MnO₂ comprises γ-MnO₂. In an embodiment, the MnO₂ comprises MnO₂ particles having a hierarchical structure. In an embodiment, the particles having a hierarchical structure are prepared by a method comprising reaction of a manganese (II) salt with an oxidizing agent in an aqueous environment. In an embodiment, the reaction comprises a hydrothermal reaction of the manganese (II) salt with the oxidizing agent. In another embodiment, the MnO₂ particles having a hierarchical structure are a particle comprising MnO₂ of the present disclosure and/or prepared by a method for preparing particles comprising MnO₂ as described herein. It will also be appreciated by a person skilled in the art that in use, an electrochemical cell comprising a cathode comprising, or consisting essentially of or consisting of a manganese oxide and an anode comprising zinc may produce other forms of materials such as manganese-zinc hydrated sulfate hydroxide (MnₓZn_{y}(OH)₂SO₄·5H₂O) and/or ZnₓMn_{y}O_{z} accordingly, such materials are also optionally contemplated in such cathodes of the present disclosure comprising, or consisting essentially of a manganese oxide. In an embodiment, the cathode, when used, comprises a lower amount of such other forms of materials in comparison to a similar cell which comprises an aqueous electrolyte comprising a zinc salt but not the lithium salt of an anionic surfactant, potassium salt of an anionic surfactant, magnesium salt of an anionic surfactant or combinations thereof.

It will be appreciated by a person skilled in the art that the cathode can optionally comprise other materials commonly used in cathodes for such rechargeable electrochemical cells. For example, in some embodiments, the cathode can optionally further include a suitable binder, electrically conductive material or combinations thereof. The binder can be any suitable binder. For example, it will be appreciated by a person skilled in the art that a suitable binder is desirably inert (e.g., at least substantially, optionally fully non-reactive to the other components in the rechargeable electrochemical cell). In an embodiment, the binder is a polyvinylidene fluoride. In another embodiment, the polyvinylidene fluoride has an Mw of about 400,000 to about 600,000 or about 534,000. The electrically conductive material can be any suitable electrically conductive material. In an embodiment, the electrically conductive material is carbon black. In an embodiment, the cathode is prepared by a method comprising the use of a suitable solvent. In an embodiment, the solvent is 1-methyl-2-pyrrolidinone. In an embodiment, the rechargeable electrochemical cell further comprises a cathode current collector. In another embodiment, the cathode is deposited on a carbon-based current collector. The carbon-based current collector can be any suitable carbon-based current collector. In an embodiment, the carbon-based current collector comprises, consists essentially of or consists of graphite foil, carbon fiber paper, carbon cloth, carbon mesh or combinations thereof. In an embodiment, the cathode comprises from about 70 wt. % to about 90 wt. %, or about 80 wt. % of the active material such as manganese oxide (e.g., MnO₂), about 5 wt. % to about 15 wt. % or about 10 wt. % binder (e.g., polyvinylidene fluoride) and about 5 wt. % to about 15 wt. %, or about 10 wt. % of the electrically conductive material (e.g., carbon black) optionally deposited on the carbon-based current collector. In an embodiment, the cathode comprises about 80 wt. % of the active material such as manganese oxide (e.g., MnO₂), about 10 wt. % binder (e.g., polyvinylidene fluoride) and about 10 wt. % of the electrically conductive material (e.g., carbon black) optionally deposited on the carbon-based current collector. It will be appreciated by a person skilled in the art that the relative amounts of active material, binder and electrically conductive material used may vary, for example, based on the identity, morphology and/or size of particles of the active material and whether the cathode comprises the MnO₂ deposited on the surface of a carbon-based material as described herein. For example, in the case of a cathode with particles comprising MnO₂ typically if lower than about 80 wt % of particles comprising MnO₂ is used, a greater percentage by weight of the electrically conductive material is used (e.g., about 75 wt. % of the particles comprising MnO₂, about 10 wt. % binder (e.g., polyvinylidene fluoride) and about 15 wt. % of the electrically conductive material (e.g., carbon black)) and if greater than about 80 wt % of particles comprising MnO₂ is used, a lower percentage by weight of the binder is used (e.g., about 82 wt. % of the particles comprising MnO₂, about 8 wt. % binder (e.g., polyvinylidene fluoride) and about 10 wt. % of the electrically conductive material (e.g., carbon black)). However, it will also be appreciated by a person skilled in the art that cathodes comprising composites comprising the MnO₂ deposited on the surface of a carbon-based material as described herein may, for example, comprise a greater percentage by weight of the particles comprising the MnO₂ (e.g., about 82 wt. %) and a lower percentage by weight of the electrically conductive material (e.g., about 8 wt. %).

The anode comprising zinc is any suitable anode comprising zinc. In an embodiment, the anode comprising zinc comprises, consists essentially of or consists of a zinc foil. In another embodiment, the zinc foil has a thickness of from about 30 μm to about 70 μm.

In an embodiment, the anode comprising zinc has been etched with acid. In an embodiment, the acid is an inorganic acid. In an embodiment, the acid comprises sulfuric acid or nitric acid. In another embodiment, the acid comprises, consists essentially of or consists of sulfuric acid. In another embodiment, the acid does not comprise HCl. In an embodiment, the anode comprising zinc has been etched with sulfuric acid. In another embodiment, the etching with sulfuric acid is for a time of about 30 seconds to about 90 seconds or about 1 minute with sulfuric acid having a concentration of about 1 M to about 5 M, about 2 M to about 4 M or about 3 M. In another embodiment, the etching with sulfuric acid is for a time of about 1 minute with sulfuric acid having a concentration of about 3 M. In an embodiment, the etching of the anode with the sulfuric acid is carried out at ambient temperature (e.g., a temperature of from about 4° C. to about 40° C. or about 25° C.).

In an embodiment, the electrochemical cell is a coin cell, a cylindrical cell, a pouch cell or a prismatic cell. In another embodiment, the electrochemical cell is a coin cell. Etching zinc under suitable conditions with an acid prior to use as an anode in an electrochemical cell such as an electrochemical cell comprising a mildly acidic electrolyte may, for example, reduce or prohibit dendritic growth and/or corrosion.

Accordingly, the present disclosure also includes a method of preparing an anode comprising zinc for use in an electrochemical cell, the method comprising contacting the zinc with an acid to etch a surface of the zinc.

In an embodiment, the electrochemical cell is a rechargeable electrochemical cell. In an embodiment, the rechargeable electrochemical cell is a rechargeable electrochemical cell comprising: a cathode comprising a particle comprising MnO₂ as described herein and/or prepared by a method for preparing particles comprising MnO₂ as described herein; an anode comprising zinc; and an aqueous electrolyte comprising a zinc salt and optionally a manganese salt, wherein the aqueous electrolyte has a pH e.g., of from about 3 to about 7 as described herein. In another embodiment, the rechargeable electrochemical cell is a rechargeable electrochemical cell comprising: a cathode; an anode comprising zinc; and an aqueous electrolyte comprising a zinc salt, a manganese salt, and an alkali metal salt, an alkaline earth metal salt or combinations thereof, wherein the aqueous electrolyte has a pH e.g., of from about 3 to about 7 as described herein. In a further embodiment, the rechargeable electrochemical cell is a rechargeable electrochemical cell comprising: a cathode; an anode comprising zinc; and an aqueous electrolyte comprising: a zinc salt; a lithium salt of an anionic surfactant, a potassium salt of an anionic surfactant, a magnesium salt of an anionic surfactant or combinations thereof; and optionally a manganese salt, an alkali metal salt, an alkaline earth metal salt or combinations thereof, wherein the aqueous electrolyte has a pH e.g., of from about 3 to about 7 as described herein. For example, in an embodiment, the anode comprising zinc comprises, consists essentially of or consists of a zinc foil. In another embodiment, the zinc foil has a thickness of from about 30 μm to about 70 μm.

In an embodiment, the acid is an inorganic acid. In an embodiment, the acid comprises sulfuric acid or nitric acid. In an embodiment, the acid comprises, consists essentially of or consists of sulfuric acid. In another embodiment, the acid is sulfuric acid. In another embodiment, the acid does not comprise HCl. In another embodiment, the etching with sulfuric acid is for a time of about 30 seconds to about 90 seconds or about 1 minute with sulfuric acid having a concentration of about 1 M to about 5 M, about 2 M to about 4 M or about 3 M. In another embodiment, the etching with sulfuric acid is for a time of about 1 minute with sulfuric acid having a concentration of about 3 M. In an embodiment, the etching of the zinc with the sulfuric acid is carried out at ambient temperature (e.g., a temperature of from about 4° C. to about 40° C. or about 25° C.).

The following are non-limiting examples of the present disclosure:

### EXAMPLES

### Example 1

### I. Materials and Methods

All chemicals were of analytical grade and were used without further purification. Manganese (II) sulfate monohydrate with the chemical formula MnSO₄·H₂O (Reagent Plus®, ≥99%, MW: 169.02 g/mol) and ammonium persulfate with the chemical formula (NH₄)₂S₂O₈ (ACS reagent, ≥98.0%, MW: 228.20 g/mol) were purchased from Sigma. X-ray powder diffraction (XRD) spectra were obtained using a Rigaku MultiFlex XRD diffractometer.

### (a) Exemplary Preparation of MnO₂ Particles:

A 0.1 M solution of MnSO₄·H₂O was prepared by dissolving MnSO₄·H₂O (1.69 g) in 80 ml of distilled water and the solution heated to 80° C. Then, a stoichiometric amount of (NH₄)₂S₂O₈ (2.282 g) was added to the clear solution to form a reactant solution under constant stirring. The solution was maintained at a temperature of 80° C. for 3 hours while continually stirring. The clear pinkish solution turned brown and then eventually turned dark brown as additional MnO₂ was produced. The pH of the solution at the end of the synthesis was about 0.3. The solution was left to cool to room temperature (about 25° C.) over about 2 hours. The solution was centrifuged and the solid MnO₂ was rinsed with ethanol and then deionized (DI) water several times until the filtered water had a pH of about 7. The resulting powder was dried at 70° C. for 8 hours. A yield of about 73% was obtained.

### (b) Exemplary Hydrothermal Preparation of MnO₂ Particles

Stoichiometric amounts of MnSO₄·H₂O (1.69 g) and (NH₄)₂S₂O₈ (2.282 g) were added to 80 ml of DI water and, after stirring at ambient temperature and pressure were heated at a temperature of 90° C. for 12 hours in an autoclave. The autoclave was left to cool to room temperature (about 25° C.) over about 3 hours. The pH of the resulting solution with brown precipitates at the end of the synthesis was about 0.5. The solution was centrifuged and the solid MnO₂ was rinsed with ethanol and then deionized (DI) water several times until the filtered water had a pH of about 7. The solids thereby obtained were dried at 60° C. for 12 hours. A yield of about 67% was obtained.

### II. Results and Discussion

The transformation process during synthesis of particles often has four key stages: nucleation, aggregation, coalescence, and growth. Nucleation can be defined as molecule cluster formation during a heterogenous reaction. On the nucleation centers, particle aggregation can occur. Depending on the temperature, the coalescence of aggregated particles can take place.

MnO₂ particles were produced by reacting ammonium persulfate with manganese (II) sulfate in aqueous solution at elevated temperatures and under ambient pressure. The reaction can be represented as follows:

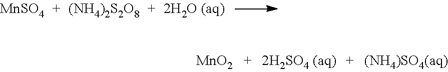

When a similar molarity of MnSO₄ and (NH₄)₂S₂O₈ were reacted in this aqueous environment, MnO₂ was obtained as a reaction product in the form of a precipitate. Depending on the conditions, the process can be used to grow particles that are spherical structures with nanowires generally uniformly and radially growing outward from the surface. Unlike the hydrothermal process, this reaction did not require high pressure in an enclosed environment (reactor) and as described in greater detail below, permits the density and particle size to be altered, for example, by regulating the rate of reaction by controlling the rate of temperature increase, for example, by varying the length of the synthesis time. Although the hydrothermal synthesis is known to provide oxide powders with size control, high quality uniform crystal growth, and high yield, several factors hinder its application on a large industry level. Even as a lab scale process, the hydrothermal synthesis requires a significantly longer reaction duration. Additionally, it is more challenging to track the reaction process and crystal growth carried out within a sealed system. The synthesis is carried out within costly reactors (pressurized vessels) that may raise safety issues. Finally, replicability of the process requires extra care as hydrothermal synthesis is extremely sensitive to precise timing and temperature. In contrast, the present method may provide a fast, replicable, low-cost, simple, and/or environmentally benign production strategy for developing, e.g., an MnO₂ active material for rechargeable Zn—MnO₂ batteries.

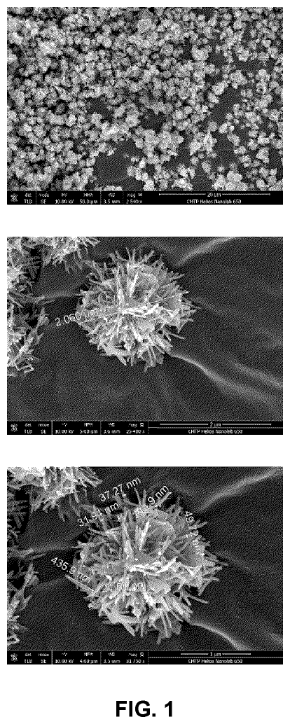

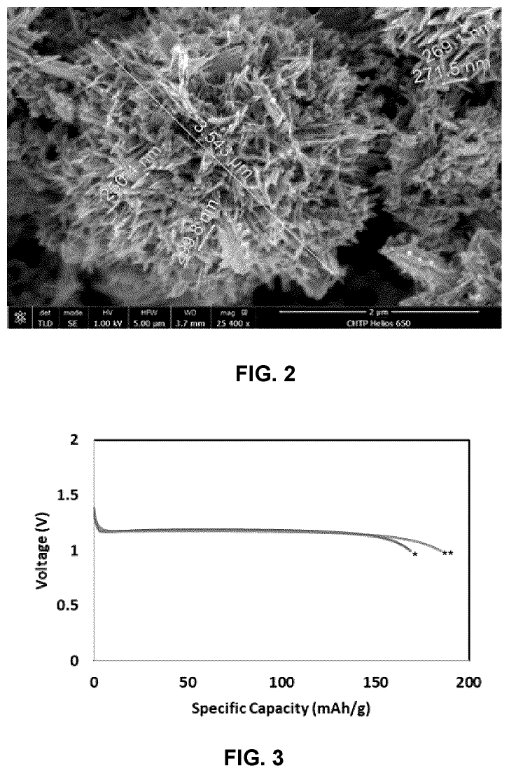

FIG. 1 shows exemplary SEM images showing the MnO₂ particles from a process carried out at 80° C. at ambient pressure for 3 hours. As can be seen in FIG. 1, the particles have a spike-like surface structure. This structure was close to sea urchin shaped MnO₂ achieved through hydrothermal synthesis at temperatures greater than 90° C. which generally takes about 12 hours (see, for example: FIG. 2). The MnO₂ product was evaluated for its electrochemical performance in a coin cell. The performance of the MnO₂ product as a cathode active material is shown in FIG. 3. The performance of the MnO₂ product was compared to hydrothermally synthesized MnO₂ cathode active material shown in FIG. 2. It was demonstrated that the MnO₂ product exhibits slightly lower first discharge capacity (mAh/g) than the hydrothermally grown MnO₂.

Preparations were also carried out in line with that described in the Materials and Methods section, but varying parameters as discussed in greater detail below.

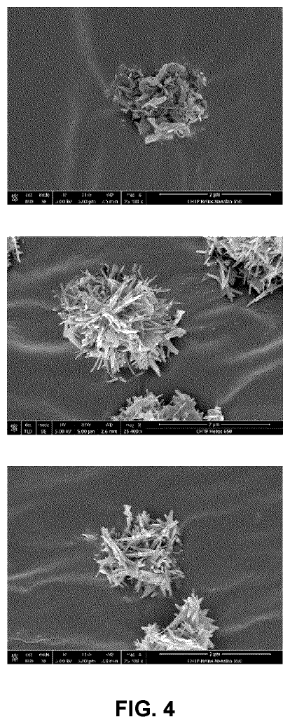

The formation of MnO₂ particles at 80° C., gave an evolution of micro-structures over time with outwards rods and petals after about 2 hours (FIG. 4, upper image) to structures with more uniform outward rods and less petals after about 4 hours (FIG. 4, middle image). However, instead of sharp nano-needles homogeneously growing outward, as observed in the hydrothermal method, in this method, finer filament-type rods with flat ends were grown outward in a more non-homogeneous manner. In general, the morphology of the MnO₂ products from this fast and scalable synthesis method can be described as spherical particles with rod-like extensions with flat ends radiating from the center of the particle. The rod-like extensions were crystalline and appeared as cut filaments that grow outward from the center of each MnO₂ particle and are less evenly distributed around the particle's center compared to the hydrothermal method. In other words, the rod-like extensions/cut filaments could be described as generally straight, outward, fine, and elongated morphologies with a close to uniform diameter throughout the structure. The “rod-like” extensions generally had a length to width ratio of at least about 5:1 and mostly about 10:1. The average length of a “rod-like” extension was typically between about 200 nm to about 500 nm and the average width was typically between about 20 nm to about 50 nm (based on SEM measurements at a magnification of about 32,000×). Beyond 4 hours, the structure appeared to have tangled rods and a more irregular morphology (FIG. 4, lower image) in comparison to the particles prepared from the 4-hour synthesis. The average diameter of the particles after 4 hours of synthesis was about 3 micrometers or less. XRD for the sample synthesized for 4 hours showed only nsutite gamma-MnO₂. A maximum yield of about 73% of the theoretical stoichiometric amount of MnSO₄ converted to MnO₂ was obtained during 4 hours of synthesis at constant temperature of 80° C. in comparison to a 67% yield of MnO₂ product achieved through hydrothermal synthesis at 90° C. for a duration of 12 hours.

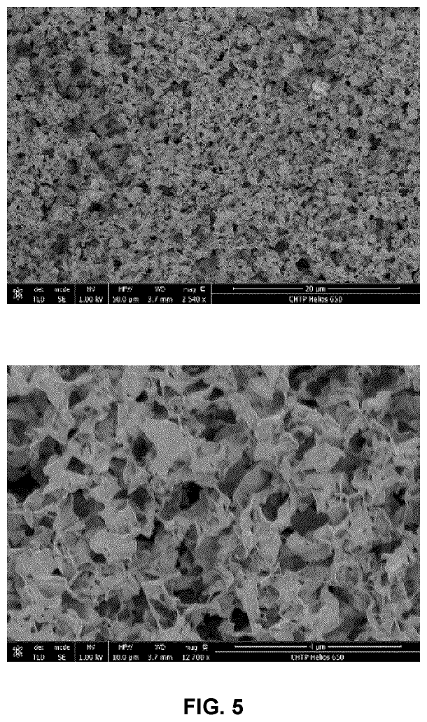

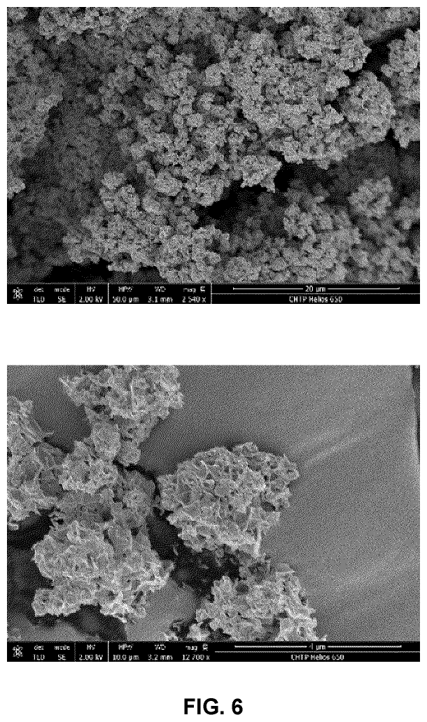

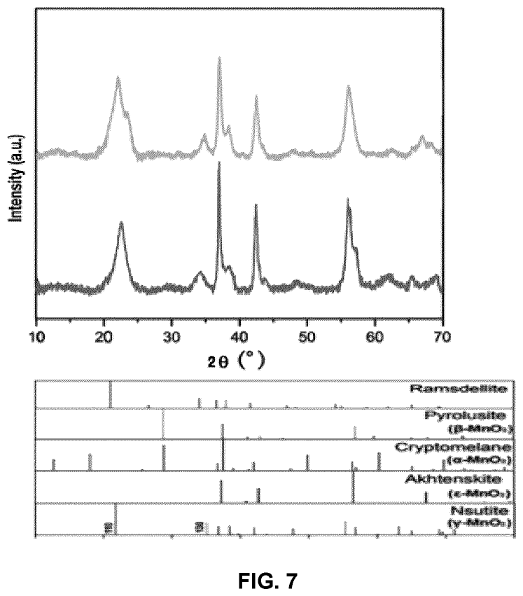

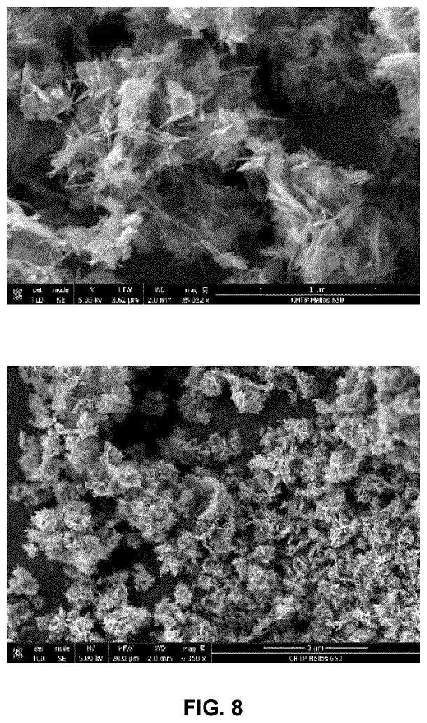

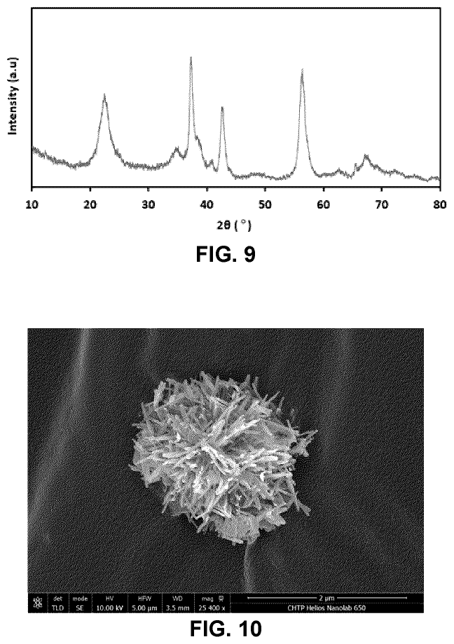

It was also observed that various properties of the MnO₂ product could be altered and controlled by changing the synthesis temperature. For example, the MnO₂ product synthesized at 80° C. had discrete particles having a spherical shape with outward rods and nsutite gamma crystalline structure in comparison to a lower temperature synthesis that prepared a MnO₂ product having interconnected forms. The majority of the particles synthesized at 80° C. for 3 to 4 hours had a diameter of about 2 to 3 μm. In general, a less homogenous and denser MnO₂ product was obtained if the reaction was carried out at a lower temperature. While not wishing to be limited by theory, at the lower temperature, a slower reaction rate results in MnO₂ particles growing to more compact structures. In a faster reaction, carried out at higher temperature, the MnO₂ particles have less time to form dense and large particles. Hence, the resulting particles tended to be smaller and less dense with rod-type structures growing outward. After mixing the salts with DI water and heating the solution to 60° C., light brown precipitates were formed within an hour. While not wishing to be limited by theory, this suggests that free Mn²⁺ ions were oxidized by the added oxidant and grew as fine nanostructures. As the synthesis proceeded over time, crystallites formed which later grew to form particles. While not wishing to be limited by theory, at a lower temperature, new nuclei are expected to form on the surface of the existing particles and not in the bulk solution. Therefore, large particles were observed after about two hours of synthesis. FIG. 5 shows images of MnO₂ synthesized at 60° C. for about 10 hours and FIG. 6 shows images of about MnO₂ synthesized at 60° C. for about 36 hours. Below 10 hours, the yield was very small; XRD diffraction peaks for MnO₂ produced at 60° C. at below 10 hours were extremely weak. Additionally, broadened and unclear peaks were indications of the amorphous nature of the material. As can be seen in the upper image of FIG. 5, the MnO₂ grown at 60° C. for about 10 hours has a sheet-like morphology with a dense and close to homogenous distribution. A higher magnification SEM image (FIG. 5, lower image) shows crosslinked porous microporous structures created by interconnected micro-sheets. As the reaction time was increased, a higher degree of macroscale assembly was observed (FIG. 6). A comparison of X-ray powder diffraction patterns showed a disappearing of the peak associated with the birnessite phase (at a time of about 6 hours), as well as a reduction in nsutite peaks and stronger akhtenskite phase peaks over time (FIG. 7). The product prepared from a synthesis at 70° C. and for a time of 7 hours demonstrated short, spike-like nano-needles and petal formation through coalescence and growth (FIG. 8). Reaction and growth were incomplete below about 7 hours and longer durations beyond 7 to 8 hours didn't have a significant effect on the morphology of the particles. XRD patterns demonstrated clear nsutite gamma-MnO₂ peaks (FIG. 9). FIG. 10 shows an exemplary MnO₂ particle prepared via reaction at 90° C. for 4 hours under ambient pressure. Except as described above no other crystalline forms of MnO₂ except γ-MnO₂ were detected in the dry MnO₂ product in the XRD results. The produced γ-MnO₂ can be compacted and used, for example, as a cathode active material in rechargeable Zn/MnO₂ cells as described in greater detail herein.

Brunauer-Emmett-Teller (B.E.T.) surface area measurements (total surface area on the exposed surfaces of particles and open pores within the particle accessible for gas adsorption/desorption) of the same molarity salt/oxidant in both 1) hydrothermal at 90° C. and after 12 hours and 2) chemical reduction on a hot plate at 80° C. and after 4 hours were measured to be 1) 34 m²/g, average pore width of 12.09 nm, and total pore volume of 0.106 cm³/g vs. 2) 46 m²/g, average pore width of 13.29 nm, and total pore volume of 0.176 cm³/g.

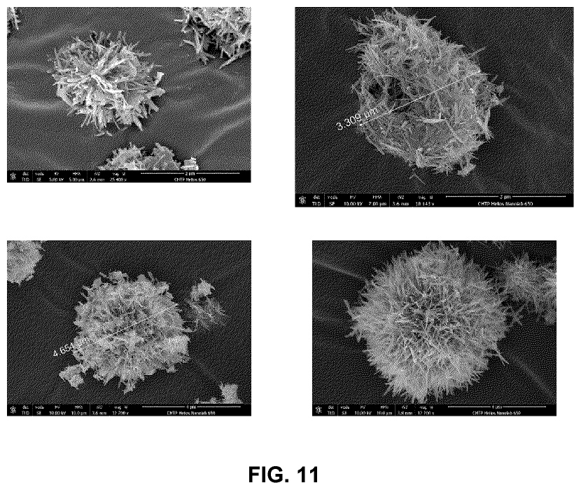

The particle size and shape of the MnO₂ product could also be controlled by varying the molarity of the salt and oxidizing agent. If the reaction mixture had a lower molarity (e.g., about 0.1 M of salt and 0.1 M of oxidant), then the MnO₂ particle size was smaller, and the distribution was more uniform. Therefore, a low variation of size and shape of individual MnO₂ particles was observed. If the molarity of the reaction mixture was increased to greater than 0.15 M of each salt (e.g., 0.33 M), the MnO₂ particles took the form of a mixture of relatively large hollow and non-uniform spherical structures comprising nanorods and smaller semi-spherical particles with outward rods non-uniformly distributed around a center. The SEM results for two different molarities using both a hydrothermal and hot plate synthesis are presented in FIG. 11. The high molarity sample prepared on the hot plate had a distribution of urchin shaped MnO₂ and tangled rods forming a hollow structure. SEM of several spots showed MnO₂ particles roughly included at least 30% gamma-MnO₂ having rods radiating outward from the surface of the particles. For the hydrothermal method, the higher molarity synthesis resulted in a larger particle with a more uniform distribution of spike-like nano-needles. XRD spectra for all four samples were similar to FIG. 9, showing only nsutite gamma-MnO₂.

It was observed that hydrothermal synthesis at higher molarities, for example an equal ratio of MnSO₄ and (NH₄)₂S₂O₈ in 80 ml vs. an equal ratio of the MnSO₄ and (NH₄)₂S₂O₈ in 30 ml water in an autoclave resulted in a significant boost in B.E.T surface area from 34 m²/g to 81 m²/g and an average pore volume increase from 0.106 cm³/g to 0.248 cm³/g. However, the Barrett, Joyner, and Halenda (BJH) desorption average pore width reduced from 12.09 to 10.6 nm. This trend was consistent over three replications of the synthesis. However, similar tests varying the molarity on the hot plate resulted in similar B.E.T surface areas of 46 vs. 48 m²/g, total pore volume of 0.176 cm³/g, and average pore width of 13.95 nm for both samples.

Samples from both the hydrothermal and hot plate low molarity synthesis showed a wider distribution of pore size and more macropores greater than 150 nm, whereas pore size distribution in the high molarity samples, especially in the hydrothermal sample demonstrated a shift to smaller pore sizes (less than 150 nm). If used as a cathode active material, e.g., in a rechargeable Zn/MnO₂ cell, a greater pore volume may, result in quicker ion transfer and/or less blockage of ion insertion into the cathode structure, which then results in improved performance.

Additionally, increased surface area provides greater accessible reaction sites for both intended and parasitic reactions. Therefore, while not wishing to be limited by theory, maximizing the surface area could advantageously result in faster capacity decay as well. Surface areas between 35 to 65 m²/g showed better capacity retention at low cycling rates in comparison to very low or very high surface area MnO₂ cathodes.

It was also observed that properties of the MnO₂ product could be modified by controlling the sequence of addition to DI water. In general, a dense product having large MnO₂ particles was obtained if the reaction was carried out by addition of MnSO₄ into heated ammonium persulfate solution. If the ammonium persulfate was added to a heated MnSO₄ solution, smaller and less compact particles with finer needles were formed when the aqueous reaction mixture under stirring was maintained at 80° C. for 4 hours.

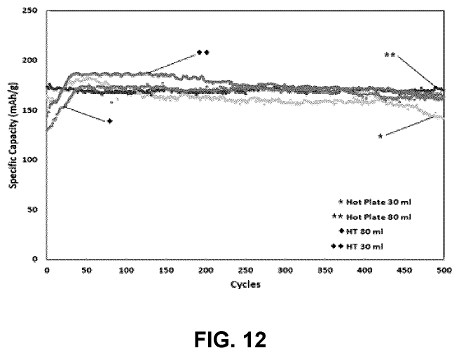

Cycling results for products produced from both hydrothermal and chemical reduction on hot plate under open air also showed that changes in structure of the manganese dioxide such as particle size, porosity, and surface area significantly affected the performance and possibility to increase the active mass loading of the cathode in a cell (FIG. 12). Products produced by synthesis in 80 ml of water for both hot plate and hydrothermal methods, showed the most stable capacity. The sample hydrothermally synthesized in 80 ml water showed a slight decay after 370 cycles. However, the slope of the capacity decay reduced after the sharp decay.

In sum, the process using heat at ambient pressure allows for the production of high purity forms of MnO₂ which can be made to have properties desirable for a given rechargeable Zn—MnO₂ battery. For example, a moderate surface area and highly stable MnO₂ product is obtainable by such a process. The capacity of the MnO₂ produced by such a method is comparable to that obtained from hydrothermal synthesis, yet the surface area and pore width of the MnO₂ particle accessible to electrolyte is greater than that obtained from hydrothermal processes, providing cycling stability for a longer duration especially at slow cycle rates e.g., <C/3.

### Example 2

### I. Materials and Methods

All chemicals were of analytical grade and were used without further purification. Manganese (II) sulfate monohydrate with the chemical formula MnSO₄·H₂O (Reagent Plus®, ≥99%, MW: 169.02 g/mol) and ammonium persulfate with the chemical formula (NH₄)₂S₂O₈ (ACS reagent, ≥98.0%, MW: 228.20 g/mol) were purchased from Sigma. Carbon nanofibers (CNF) were purchased from Sigma Aldrich (Quality level 200, assay >98% carbon basis MW: 12.01, D×L: about 100 nm×about 20 to about 200 μm). X-ray powder diffraction (XRD) spectra were obtained using a Rigaku MultiFlex XRD diffractometer.

### (a) Exemplary Preparation of MnO₂ Particles Deposited on Carbon Nanofibers (CNF)

The MnO₂/CNF composite was produced in a manner similar to that described for the preparation of MnO₂ particles described above in exemplary preparation (a) in the Materials and Methods section of Example 1 except that CNF were added to the reaction mixture to allow active material growth on conductive fibers. A 0.1 M solution of MnSO₄·H₂O was prepared by dissolving MnSO₄·H₂O in 80 ml of DI water in a glass beaker, 0.25 wt % of resulting MnO₂ (yield calculated based on the above-mentioned exemplary preparation of MnO₂ particles) CNF were added to the solution and the solution heated to 90° C. Then, persulfate was added (in an amount to obtain a solution 0.1M in persulfate) to the heated solution under constant stirring for 5 hours. The temperature was maintained for another hour without mixing the solution. Then, the solution was left to cool to room temperature (about 25° C.) over about 2 hours. The solution was centrifuged, and the solid product was rinsed first with ethanol and then DI water several times until the filtered water had a pH of about 7. The resulting powder was dried at 70° C. for 8 hours.

### (b) Exemplary Hydrothermal Preparation of MnO₂ Particles Deposited on CNF

The MnO₂/CNF composite was produced in a manner similar to that described for the hydrothermal preparation of MnO₂ particles described above in exemplary preparation (b) in the Materials and Methods section of Example 1 except that CNF were added to the reaction mixture to allow active material growth on conductive fibers. Stoichiometric amounts of MnSO₄·H₂O (1.69 g) and (NH₄)₂S₂O₈ (2.282 g) plus 0.25 wt. % of expected yield of resulting MnO₂ CNF were added to 80 ml of DI water and, after stirring at ambient temperature and pressure, the mixture was transferred to an autoclave and was heated at a temperature of 90° C. for 12 hours. The autoclave was left to cool to room temperature (about 25° C.) over about 3 hours. The solution was centrifuged, and the solid product was rinsed first with ethanol and then DI water several times until the filtered water had a pH of about 7. The resulting powder was dried at 70° C. for 8 hours.

### II. Results and Discussion

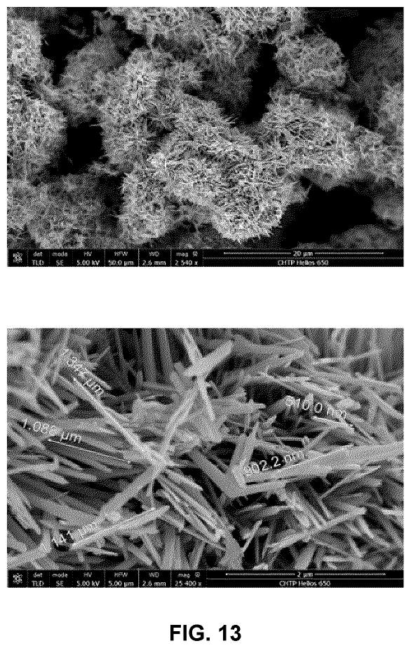

The reaction mixture can be seeded with carbon-based materials including CNFs and such a material will act as a substrate the MnO₂ reaction product to precipitate directly on the solid material. For example, the product produced in this example was made up of MnO₂ deposited substantially uniformly over the surface of the individual CNF to form a hybrid CNF/MnO₂ product (FIG. 13, upper image). Each strand of the hybrid carbon/MnO₂ product retained the overall fiber shape of CNF but exhibited a fiber surface formed of substantially uniformly distributed needle-like MnO₂ (FIG. 13, lower image). An advantage of this product is that it has higher conductivity which facilitates electron transfer in the bulk of the electrode as well as MnO₂ structure.

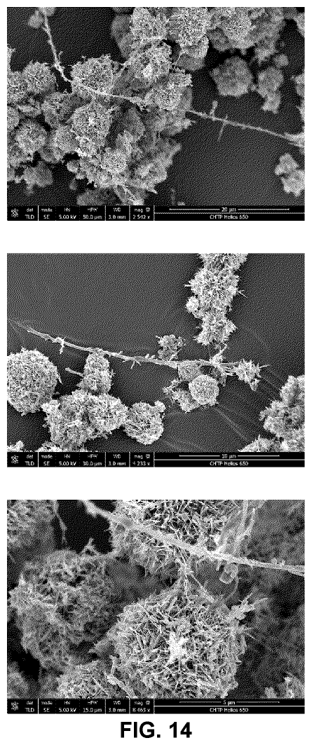

In contrast, the reaction mixture in the hydrothermal method did not demonstrate carbon-based material seeding. Instead of acting as a conductive substrate for MnO₂ reaction product for direct growth, the CNF acted as an independent nonreactive additive in the solution. Therefore, the product synthesized in this example was made up of some sea urchin-type MnO₂ grown around CNF and some sea urchin-type MnO₂ grown independently to form a mixture of CNF/MnO₂ product (FIG. 14). Strands of CNF were visible in the SEMs and no needle-like MnO₂ distribution on the nanofibers was observed.

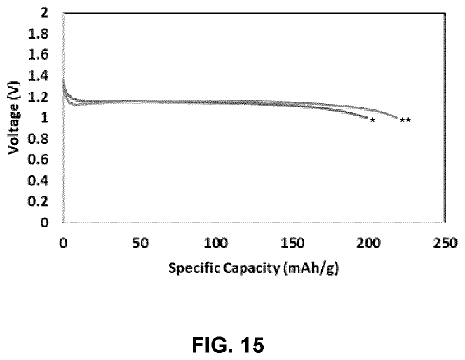

The CNF/MnO₂ product was evaluated for its performance in a coin cell setup. This cell used a zinc foil anode and an Mg-electrolyte and a glass fiber separator. Instead of the conventional 80:10:10 wt % ratio for cathode slurry production, a mixture of 82.25 wt % CNF/MnO₂ was mixed with 7.75 wt % carbon black (CB) and 10 wt % polyvinylidene fluoride (PVDF) binder. Two cells were made with one containing the CNF/MnO₂ product as cathode material and the other MnO₂/CNF prepared through the hydrothermal method. The performance of the two cells was compared at C/8 and the results shown in FIG. 15.

### Example 3

### I. Materials

Zinc sulfate heptahydrate with the chemical formula ZnSO₄·7H₂O (ACS reagent, 99%, MW: 278.56 g/mol) and manganese (II) sulfate monohydrate with the chemical formula MnSO₄·H₂O (Reagent Plus®, ≥99%, MW: 169.02 g/mol) were purchased from Sigma. Anhydrous magnesium sulfate with the chemical formula MgSO₄ (certified ACS, >99%, MW: 246.47 g/mol) was purchased from Fisher Chemical. Ethylene glycol with the chemical formula C₂H₆O₂ (Reag. Ph. Eur. ≥99.5%, MW: 62.07) and silica with the formula SiO₂ (99.8%) were purchased from Sigma. Sulfuric acid with chemical formula H₂SO₄ (99.999%, MW: 98.08) was purchased from Sigma. All of the chemicals used for the preparation of the aqueous electrolyte were analytical reagent grade and were used without further purification.

### II. General Preparation of Electrolytes

Standard electrolyte was prepared by mixing 2.875 g of ZnSO₄ and 0.169 g of MnSO₄ in 10 mL deionized water. Mg-electrolyte was prepared by mixing 2.875 g of ZnSO₄, 0.169 g of MnSO₄, and 1.23 g of MgSO₄ in 10 mL deionized water. The solutions were stirred for several minutes until all of the salts dissolved. The electrodes and the separator were soaked in the uniformly mixed electrolyte for 5 minutes before fabrication. Colloidal electrolyte was prepared by mixing SiO₂ and liquid electrolyte in a mass ratio of 1:10. The pH of the electrolytes were in the range of 3.9 to 4.3 and depended on the salt molarity.

### III. General Fabrication of Batteries

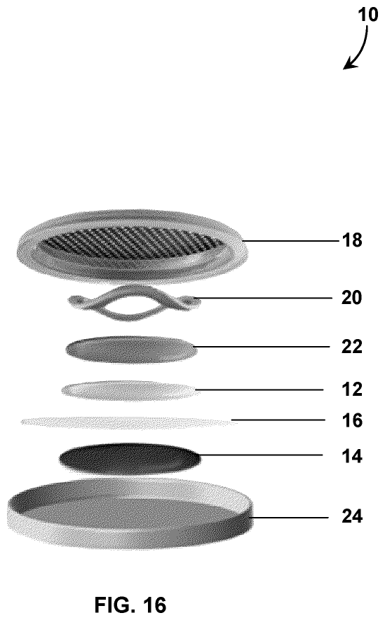

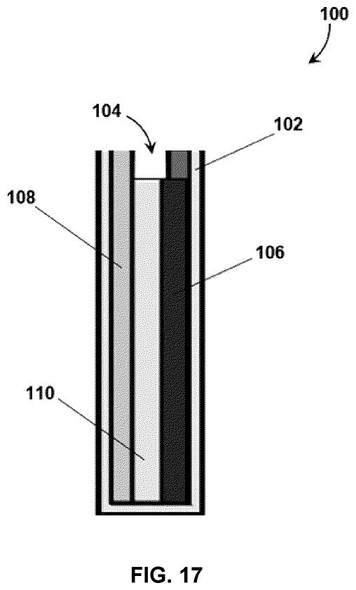

Coin cell batteries having a structure in line with the schematic illustrated in FIG. 16 were assembled in a conventional coin cell assembly machine. Referring to FIG. 16, an exemplary coin cell battery 10 includes an anode 12 (30-70 μm zinc foil) and a cathode 14 (4 to 10 mg/cm² MnO₂/conductive additive/binder) separated by a separator 16. Also shown in FIG. 16 is a lid 18, spring 20, current collector 22 and base 24. Batteries having a structure in line with the schematic illustrated in FIG. 17 were assembled by pressing the two electrodes against the separator in a quartz cuvette. Referring to FIG. 17, the exemplary battery 100 shown therein includes a quartz cuvette 102 with a gas outlet 104 and internal components including anode 106 (30-70 μm zinc foil) and cathode 108 (5 to 10 mg/cm² MnO₂) separated by separator 110. The anode was a 30 to 70 μm thick zinc foil, the cathode was prepared by doctor blading a slurry of 80% MnO₂ powder (about 2-6 μm), 10% poly(vinylidene fluoride) (PVDF) (Mw about 534,000), 10% carbon black (SP+), and 1-methyl-2-pyrrolidinone (NMP) on 50 μm graphite foil. However, other thick, carbon-based current collectors such as carbon fiber paper, carbon cloth or carbon mesh could be used. The zinc deposition amount was 1.5 mAh/cm² in all of the Zn//Zn stripping and plating tests.

### IV. Results and Discussion

The electrochemical performance of a Zn—MnO₂ battery was improved by adding a metal sulfate salt as a supporting electrolyte. The addition of the metal sulfate resulted in superior cyclability of the cells at C/2 (practical: about 1 hour charge and about 1 hour discharge) and C/4 (practical: about 2 hours charge and about 2 hours discharge) in comparison to standard ZnSO₄/MnSO₄ electrolyte. While not wishing to be limited by theory, addition of the metal sulfate into the standard ZnSO₄/MnSO₄ electrolyte contributes to a greater rate of Mn²⁺ deposition, the reversibility of both MnO₂ dissolution/Mn²⁺ deposition and hydroxide hydrated layer formation while reducing hydrogen evolution and delaying the zinc corrosion.

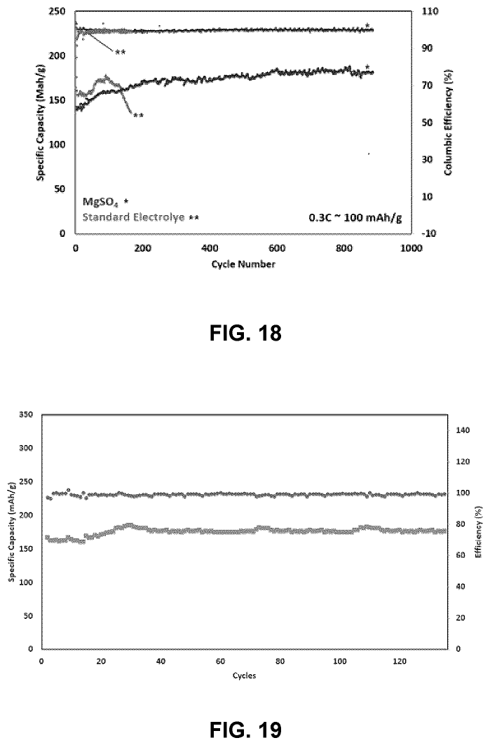

FIG. 18 shows cycling results of standard electrolyte: 1M ZnSO₄ and 0.1M MnSO₄ (**). The stable cyclability of the cell at C/3 was limited to about 100 cycles. Tests on multiple cells with standard electrolyte have shown similar rapid capacity decay after about 100 to 150 cycles at C/3. While not wishing to be limited by theory, this decay can be attributed to the quasi-reversible formation of zinc layered double hydroxide (ZnLDH) and ion diffusion path blockage due to precipitation of ZnLDH and less electrochemically active by-product formation/deposition (i.e. ZnMn₂O₄) on the electrode surface (Alfaruqi et al., 2015). Furthermore, hydrogen evolution and precipitation of ZnLDH are known to cause gradual zinc corrosion on the anode side (Alfaruqi et al., 2015; Fitz et al., 2021). In contrast, as shown in FIG. 18, addition of magnesium sulfate into the electrolyte has significantly improved the cycle stability of the coin cell (* indicates results of metal salt added electrolyte: 1M ZnSO₄ and 0.1M MnSO₄ with 0.5M MgSO₄).

Similar specific charge/discharge capacity plateaus of both standard and salt added electrolyte in a coin cell arrangement shows that the reaction mechanisms of the battery may be unaffected by the addition of the supporting salt. However, there is a significant capacity decay in the standard electrolyte, while not wishing to be limited by theory, possibly due to formation of an inactive by-product (i.e. ZnMn₂O₄) and pore blockage on the surface of the cathode. The electrolyte with added MgSO₄ shows negligible decay over 880 cycles (FIG. 18). FIG. 19 shows the results of a long rest time cycling protocol for a cell with a cathode having an area of 1.18 cm² (capacity=about 180 mAh/g) with electrolyte including 1M ZnSO₄ and 0.1M MnSO₄ with 0.5M MgSO₄. The cell was fully charged at C/4, then rested at open-circuit voltage (OCV) for one hour, fully discharged at C/12 to the cut-off voltage, rested at OCV for 12 hours, then these steps were repeated.

Based on electrochemical tests: cyclic voltammetry, electrochemical impedance spectroscopy (EIS), charge discharge, and pH measurements; and surface/elemental characterization: ex-situ X-ray powder diffraction (XRD) and scanning electron microscopy (SEM), so far, while not wishing to be limited by theory, the addition of the supportive salts to the electrolyte solution may result in the reversibility of ZnLDH formation and facilitate the redeposition of higher amounts of MnO₂ on the cathode:

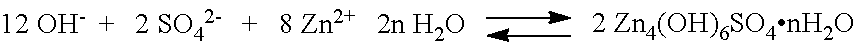

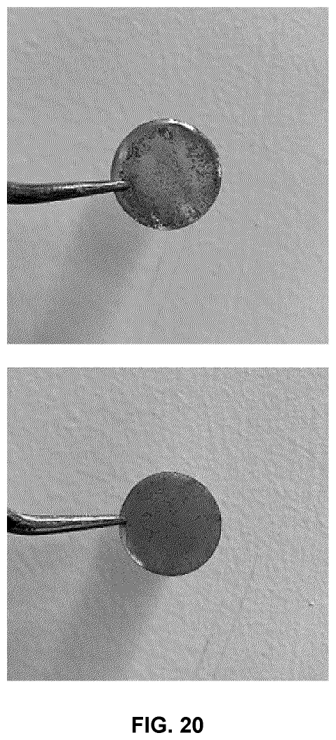

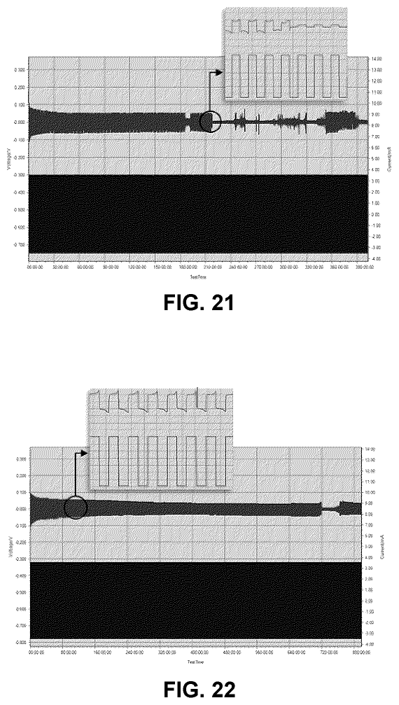

Further, the addition of supportive salts was observed to reduce the gas evolution in the cells. Gas evolution was especially observable when the cells were charged to 1.9V resulting in accelerated hydrogen evolution, evident from inflated coin cells, increased inner pressure, and increased internal resistance due to deteriorated contact. FIG. 20 shows a comparison between Zn anodes after a certain number of hours constant current charge discharge at C/3. As can be observed in FIG. 20, the zinc anode in a cell with electrolyte including 1M ZnSO₄, 0.1M MnSO₄, and 0.5M MgSO₄ (lower image) shows less surface etching after about 200 cycles in comparison to standard electrolyte cycling after about 120 cycles (upper image). Therefore, while not wishing to be limited by theory, Zn corrosion may be delayed but not hindered due to addition of the MgSO₄. Additionally, as evident from FIG. 21 and FIG. 22, positive ion shielding (X²⁺) on the surface of the anode is an effective technique to prevent Zn corrosion during long cycling or at higher current densities.

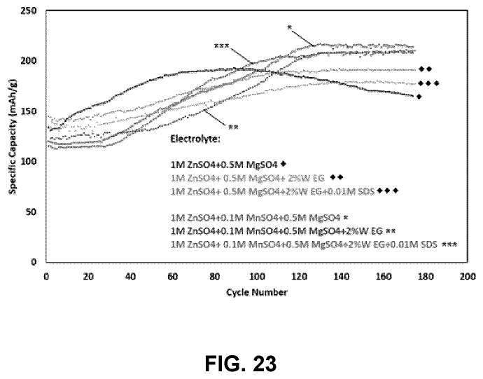

The effect of adding other additives to the electrolyte was also investigated. For example, FIG. 23 shows the results for coin cell batteries having standard electrolyte (1M ZnSO₄ and 0.5M MgSO₄) in comparison to electrolyte with 1M ZnSO₄, 0.5M MgSO₄ and 0.5 vol % ethylene glycol (EG); electrolyte with 1M ZnSO₄, 0.5M MgSO₄, 0.5 vol % EG and 0.01M sodium dodecyl sulfate (SDS); electrolyte with 1M ZnSO₄, 0.1M MnSO₄, and 0.5M MgSO₄; electrolyte with 1M ZnSO₄, 0.1M MnSO₄, 0.5M MgSO₄ and 0.5 vol % EG; and electrolyte with 1M ZnSO₄, 0.1M MnSO₄, 0.5M MgSO₄, 0.5 vol % EG and 0.01M SDS.

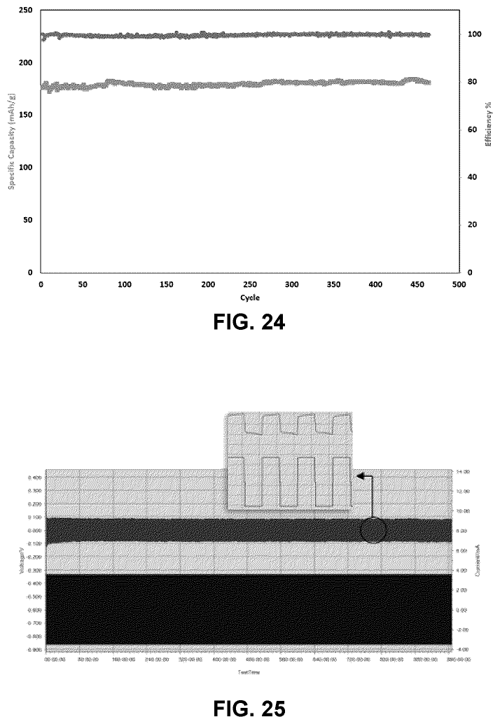

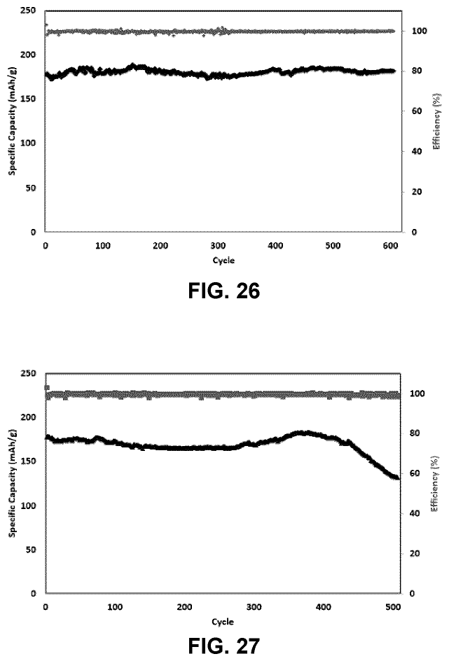

Magnesium lauryl sulfate was also investigated as a replacement for SDS which is a common surfactant in water-based batteries. Our corrosion tests show that magnesium lauryl sulfate pushed Zn corrosion current to a smaller number (higher corrosion resistance) and pushed hydrogen evolution overvoltage to a larger number. At very slow C-rates, batteries with SDS additive showed a faster than expected decay. While not wishing to be limited by theory, this could be because Nat ions from SDS may be competing with Mg²⁺ ions of MgSO₄ in the electrolyte. Na⁺ ions even as NaSO₄ show low efficiency and a faster decay compared to MgSO₄, K₂SO₄ and Li₂SO₄. A sample cycling result at C/3 for a battery with gamma MnO₂ synthesized in 80 ml water on a hot plate, Zn etched in 3M H₂SO₄ for 1 minute and 1M ZnSO₄, 0.1M MnSO₄ and 0.5M MgSO₄ electrolyte with 0.5 mM magnesium lauryl sulfate was conducted. The Zn—MnO₂ coin cells and symmetric Zn//Zn cells with magnesium lauryl sulfate surfactant have been running without showing any decay for 960 hours so far. FIG. 24 shows C/3 constant current cycling results. FIG. 25 shows Zn/Zn symmetric cycling results. A sample cycling result at C/4 for a battery with gamma MnO₂ synthesized in 80 ml water on a hot plate, Zn etched in 3M H₂SO₄ for 1 minute and 1M ZnSO₄, 0.1M MnSO₄ and 0.5M Li₂SO₄ electrolyte with 0.5 mM magnesium lauryl sulfate was also conducted. FIG. 26 shows C/4 constant current cycling results. FIG. 27 shows C/4 constant current cycling results for a similar battery but without the magnesium lauryl sulfate. The data shows an advantage of magnesium lauryl sulfate in this system in comparison to e.g., sodium dodecyl sulfate which failed faster and tended to lower the charge/discharge efficiency. Potassium lauryl sulfate may be predicted to have similar advantages in electrolytes, e.g., containing a potassium additive. Lithium lauryl sulfate may also be predicted to have similar advantages in electrolytes, e.g., containing a lithium additive.

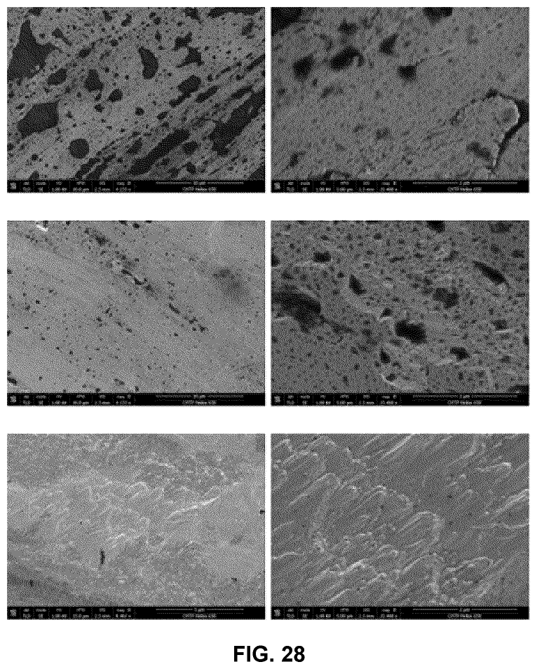

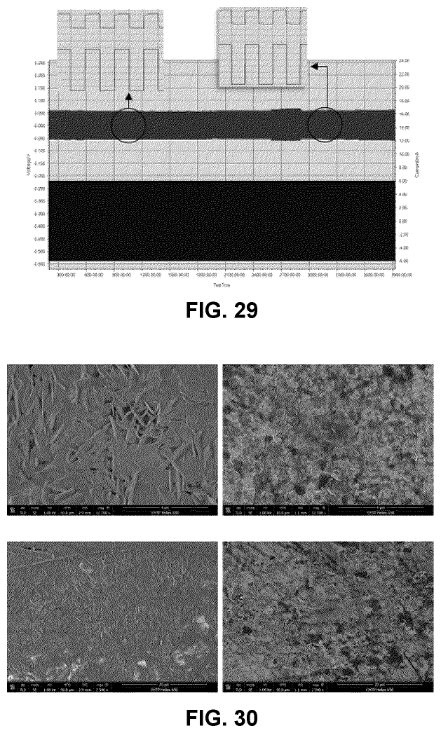

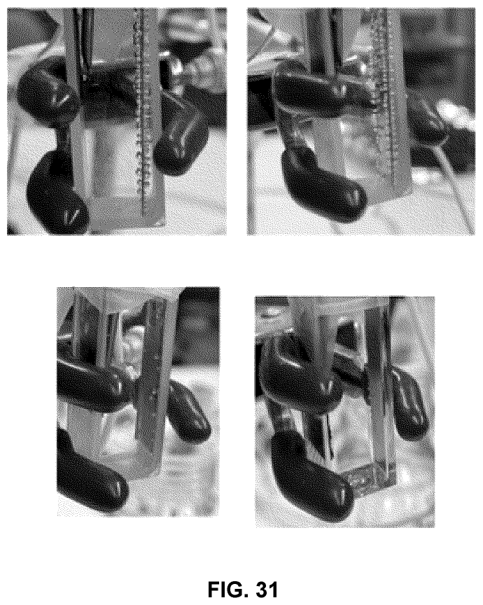

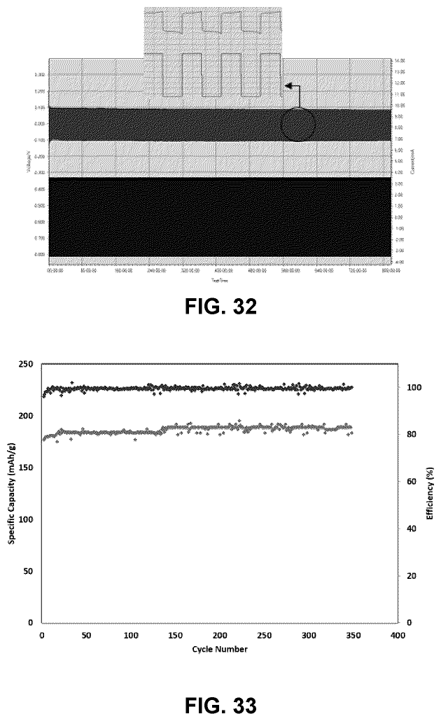

The effect of etching Zn electrodes in H₂SO₄ was also investigated. FIG. 28 shows exemplary SEM images of zinc treated with various concentrations of H₂SO₄ for one minute. It was found that treatment with 3M H₂SO₄ for 1 minute was advantageous over the treatment with 1M H₂SO₄ or 5M H₂SO₄. FIG. 29 shows the results for a coin cell battery having a zinc electrode etched for 1 minute in 3M H₂SO₄ and an electrolyte including 1M ZnSO₄, 0.1M MnSO₄, and 0.5M MgSO₄ over about 3900 hours. Following this procedure for acid etching has provided better results than any reported results the inventors are aware of for prohibition of dendric growth and corrosion in such a system. Long lasting cycling (uniform deposition and stripping) and reduction of side reactions by corrosion are closely related to surface area, morphology, and initial nucleation of the zinc. Nucleation overpotential shifts and crystallographic growth are different based on different surface treatments and etching procedures in the same electrolyte. The surface produced by etching the zinc for one minute using 3M H₂SO₄ takes advantage of increased nucleation overpotential and enhanced corrosion protection (reduced corrosion current and increased corrosion potential) in comparison to non-etched Zn and Zn etched in other lower or higher molarities and/or longer and shorter etching times investigated. FIG. 30 shows a comparison of a Zn surface etched with 3M H₂SO₄ (right images) in comparison to Zn surface that was not etched after 350 cycles when used as an anode in a battery with an electrolyte including 1M ZnSO₄, 0.1M MnSO₄, and 0.5M MgSO₄. FIG. 31 shows photographs of exemplary batteries in quartz cuvettes. The least amount of gas bubbles was observed for the battery with an electrolyte including 1M ZnSO₄, 0.1M MnSO₄, 0.5M MgSO₄ and 0.5 vol % ethylene glycol and with a zinc electrode etched for 1 minute in 3M H₂SO₄. FIG. 32 illustrates the results for a coin cell having zinc electrodes etched for 1 minute in 3M H₂SO₄ and an electrolyte including 1M ZnSO₄, 0.1M MnSO₄, 0.5M MgSO₄, and 0.5 vol % ethylene glycol (EG).

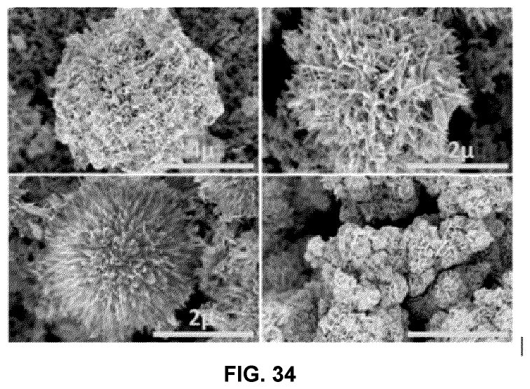

C/3 constant current charging and discharging was also conducted in a coin cell battery which had SiO₂-supported 1M ZnSO₄, 0.1M MnSO₄, 0.5M MgSO₄ and 0.5 vol % ethylene glycol (EG) electrolyte (FIG. 33). The separator was sandwiched between two layers of high viscosity electrolyte slurry. As can be observed in FIG. 33, the capacity also had desirable stability when SiO₂ was added to the system. Based on linear polarization tests, polarization current was lowest with the addition of SiO₂<addition of EG<addition of MgSO₄. Therefore, the corrosion rate was lower with all three additives, as well as having stable capacity.

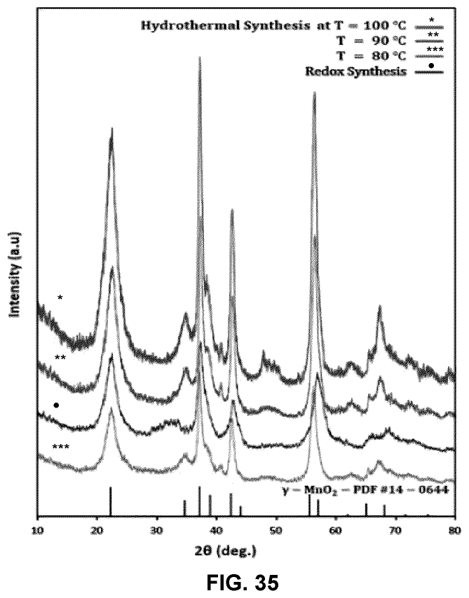

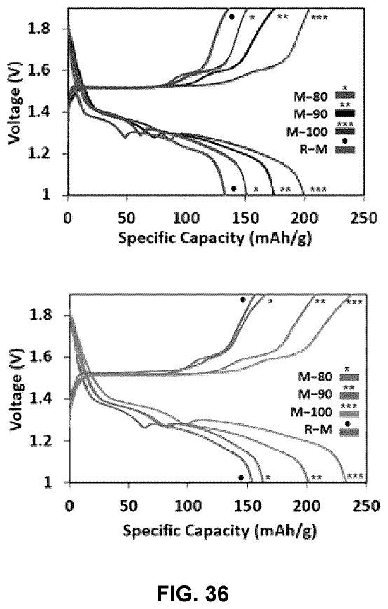

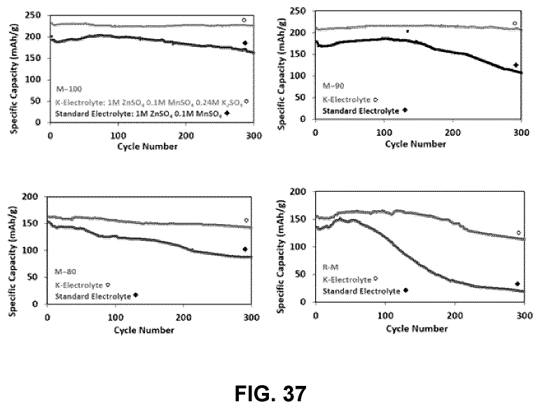

FIG. 34 shows exemplary SEM images of three structures obtained through hydrothermal synthesis at 80, 90, and 100° C., and a flower-like structure obtained through chemical reduction of potassium permanganate (KMnO₄) and manganese chloride (MnCl₂) at room temperature. The XRD results for these samples are shown in FIG. 35. The XRD peaks of all samples were indexed to γ-MnO₂ (PDF #14-0644). The peak intensities increased as the hydrothermal synthesis temperature increased due to the more crystalline structure of the products formed. The nanoflake sample exhibited broadened peaks suggesting the presence of nano-sized crystals. A comparison between these different MnO₂ structures was undertaken using batteries with electrolyte including 1M ZnSO₄ and 0.1M MnSO₄ (standard electrolyte) and 1M ZnSO₄, 0.1M MnSO₄ and 0.25M K₂SO₄ (potassium-containing electrolyte). The galvanostatic first charge/second discharge and the cycle life stability of the synthesized γ-MnO₂ at a rate of 0.25 C in both standard and the K-electrolyte is shown in FIG. 36 and FIG. 37, respectively. The capacity was calculated by active mass loadings of 2.5-3 mg·cm⁻². All of the electrodes showed a similar redox behavior with charge discharge plateaus consistent with the peaks in other electrochemical tests, indicating the morphological modification of the cathode and electrolyte additives such as K₂SO₄ or MgSO₄ did not substantially affect the redox reaction in the cell. However, the role of the modified cathode morphology and electrolyte modification is evident in the plots. Particles that were synthesized at 90 and 100° C. demonstrated the most stable behaviour in both standard and electrolyte with additive. Particles that were synthesized at 80° C. and from the redox reaction at room temperature revealed poor cyclability. While not wishing to be limited by theory, this was mainly due a larger size and random distribution of rods, and the dense structure of nanoflowers, respectively, resulting in larger internal resistance and poorer ion transfer abilities.

The advantages of the above-described findings may include battery material, electrolyte solution, and fabrication that is low cost, durable, and safe. The electrolyte solution includes a water-based electrolyte and optionally a salt additive. The salt additive is a metal salt which delays the battery performance decay and increases the battery lifecycle which makes this finding valuable in meeting some of the requirements for long lifecycle energy storage systems.

While the present disclosure has been described with reference to examples, it is to be understood that the scope of the claims should not be limited by the embodiments set forth in the examples, but should be given the broadest interpretation consistent with the description as a whole.

All publications, patents and patent applications are herein incorporated by reference in their entirety to the same extent as if each individual publication, patent or patent application was specifically and individually indicated to be incorporated by reference in its entirety. Where a term in the present application is found to be defined differently in a document incorporated herein by reference, the definition provided herein is to serve as the definition for the term.

### FULL CITATIONS FOR REFERENCES REFERRED TO IN THE DESCRIPTION

M. H. Alfaruqi, V. Mathew, J. Gim, S. Kim, J. Song, J. P. Baboo, S. H. Choi, and J. Kim, “Electrochemically induced structural transformation in a γ-MnO₂ cathode of a high capacity zinc-ion battery system.” Chem. Mater. 2015, 27:10, 3609-3620.
D. Larcher, and J. M. Tarascon, “Towards greener and more sustainable batteries for electrical energy storage” Nat. Chem. 2015, 7, 19-29.
P. Oberholzer, E. Tervoort, A. Bouzid, A. Pasquarello, and D. Kundu, “Oxide versus nonoxide cathode materials for aqueous Zn batteries: An insight into the charge storage mechanism and consequences thereof” ACS Appl. Mater. Interfaces 2019, 11, 674-682.
O. Fitz, C. Bischoff, M. Bauer, H. Gentischer, K. P. Birke, H.-M. Henning, and D. Biro, “Electrolyte study with in operando Ph tracking providing insight into the reaction mechanism of aqueous acidic Zn//MnO₂ batteries.” ChemElectroChem 2021, 8:18, 3553-3566.
Y. Li, S. Wang, J. R. Salvador, J. Wu, B. Liu, W. Yang, J. Yang, W. Zhang, J. Liu, and J. Yang, “Reaction mechanisms for long-life rechargeable Zn/MnO₂ batteries” Chem. Mater. 2019, 31, 6, 2036-2047.
H. Pan, Y. Shao, P. Yan, Y. Cheng, K. S. Han, Z. Nie, C. Wang, J. Yang, X. Li, P. Bhattacharya, K. T. Mueller, and J. Liu, “Reversible aqueous zinc/manganese oxide energy storage from conversion reactions” Nat. Energy 2016, 1, 1-7.
J. H. Zeng, Y. F. Wang, Y. Yang, and J. Zhang, “Synthesis of sea-urchin shaped γ-MnO₂ nanostructures and their application in lithium batteries” 2010, J. Mater. Chem. 2010, 20, 10915-10918.
Y. Zhang, and N. Liu, “Nanostructured electrode materials for high-energy rechargeable Li, Na and Zn batteries” Chem. Mater. 2017, 29, 9589-9604.

1. A rechargeable electrochemical cell, comprising:
a cathode;
an anode comprising zinc; and
an aqueous electrolyte comprising:
a zinc salt;
a lithium salt of an anionic surfactant, a potassium salt of an anionic surfactant, a magnesium salt of an anionic surfactant or combinations thereof; and
optionally a manganese salt, an alkali metal salt, an alkaline earth metal salt or combinations thereof,
wherein the aqueous electrolyte has a pH of from about 3 to about 7.

2. The rechargeable electrochemical cell of claim 1, wherein the aqueous electrolyte comprises the magnesium salt of the anionic surfactant and wherein the anionic surfactant is magnesium lauryl sulfate.

3. The rechargeable electrochemical cell of claim 1 or 2, wherein the anode comprising zinc is a zinc foil.

4. The rechargeable electrochemical cell of any one of claims 1 to 3, wherein the anode comprising zinc has been etched with acid.

5. The rechargeable electrochemical cell of claim 4, wherein the etching with acid is for a time of about 1 minute with sulfuric acid having a concentration of about 3 M.

6. The rechargeable electrochemical cell of any one of claims 1 to 5, wherein the cathode comprises a manganese oxide, a zinc manganese oxide, a manganese-zinc hydrated sulfate hydroxide, a zinc hydroxide sulfate hydrate, or combinations thereof.

7. The rechargeable electrochemical cell of any one of claims 1 to 6, wherein the cathode comprises MnO₂.

8. The rechargeable electrochemical cell of claim 7, wherein the MnO₂ is undoped MnO₂.

9. The rechargeable electrochemical cell of claim 7, wherein the MnO₂ comprises γ-MnO₂.

10. The rechargeable electrochemical cell of claim 7, wherein the MnO₂ comprises MnO₂ particles having a hierarchical structure.

11. The rechargeable electrochemical cell of any one of claims 1 to 10, wherein the zinc salt is zinc sulfate and the aqueous electrolyte comprises the manganese salt, wherein the manganese salt is manganese (II) sulfate.

12. The rechargeable electrochemical cell of any one of claims 1 to 11, wherein the aqueous electrolyte comprises the alkali metal salt.

13. The rechargeable electrochemical cell of claim 12, wherein the alkali metal salt is potassium sulfate.

14. The rechargeable electrochemical cell of any one of claims 1 to 11, wherein the aqueous electrolyte comprises the alkaline earth metal salt.

15. The rechargeable electrochemical cell of claim 14, wherein the alkaline earth metal salt is magnesium sulfate.

16. The rechargeable electrochemical cell of any one of claims 1 to 15, wherein the aqueous electrolyte comprises about 1 M zinc sulfate, about 0.1 M manganese (II) sulfate and about 0.5 M magnesium sulfate.

17. The rechargeable electrochemical cell of any one of claims 1 to 16, further comprising a separator separating the cathode and the anode.

18. The rechargeable electrochemical cell of any one of claims 1 to 17, wherein the aqueous electrolyte has a pH of from about 3.8 to about 5.

19. The rechargeable electrochemical cell of any one of claims 1 to 18, wherein the aqueous electrolyte further comprises ethylene glycol.

20. The rechargeable electrochemical cell of claim 19, wherein the aqueous electrolyte comprises at least about 0.5 vol % ethylene glycol mixed with a secondary organic additive agent selected from salicylaldehyde (SAL), benzylideneacetone (BDA), benzylacetone (BA), butylbenzene (BB) and combinations thereof.

21. The rechargeable electrochemical cell of any one of claims 1 to 20, wherein the aqueous electrolyte further comprises silicon dioxide.

22. The rechargeable electrochemical cell of any one of claims 1 to 21, further comprising a cathode current collector.

23. The rechargeable electrochemical cell of claim 22, wherein the cathode is deposited on a carbon-based current collector comprising graphite foil, carbon fiber paper, carbon cloth or combinations thereof.

24. The rechargeable electrochemical cell of any one of claims 1 to 23, that is a coin cell, a cylindrical cell, a pouch cell or a prismatic cell.

25. A use of a lithium salt of an anionic surfactant, a potassium salt of an anionic surfactant, a magnesium salt of an anionic surfactant or combinations thereof in an aqueous electrolyte for a rechargeable electrochemical cell.

26. An aqueous electrolyte comprising a lithium salt of an anionic surfactant, a potassium salt of an anionic surfactant, a magnesium salt of an anionic surfactant or combinations thereof for use in a rechargeable electrochemical cell.

27. The use of claim 25 or aqueous electrolyte for use of claim 26, wherein corrosion resistance of the anode in the rechargeable electrochemical cell is increased.

28. The use or aqueous electrolyte for use of any one of claims 25 to 27, wherein hydrogen evolution in the rechargeable electrochemical cell is decreased.

29. The use or aqueous electrolyte for use of any one of claims 25 to 28, wherein the aqueous electrolyte comprises the magnesium salt of the anionic surfactant and wherein the anionic surfactant is magnesium lauryl sulfate.

30. The use or aqueous electrolyte for use of any one of claims 25 to 29, wherein the aqueous electrolyte and/or the electrochemical cell is as defined in any one of claims 1 and 3 to 24.

31. A method for preparing particles comprising MnO₂, the method comprising:
reacting a manganese (II) salt with an oxidizing agent in an aqueous environment at a pressure lower than about 0.2 MPa and a temperature of from about 40° C. to about 100° C. to produce the particles comprising the MnO₂.

32. The method of claim 31, wherein the reaction is carried out at ambient pressure.

33. The method of claim 31 or 32, wherein the manganese (II) salt comprises MnSO₄.

34. The method of any one of claims 31 to 33, wherein the oxidizing agent is a persulfate.

35. The method of claim 34, wherein the oxidizing agent comprises (NH₄)₂S₂O₈.

36. The method of any one of claims 31 to 35, wherein the concentration of the manganese (II) salt and the oxidizing agent in the aqueous environment is from about 0.05 M to about 0.5 M.

37. The method of any one of claims 31 to 36, wherein the method comprises adding the oxidizing agent to an aqueous solution comprising the manganese (II) salt.

38. The method of any one of claims 31 to 37, wherein the reaction is carried out at a temperature of from about 70° C. to about 100° C.

39. The method of any one of claims 31 to 37, wherein the reaction is carried out at a temperature of from about 80° C. to about 90° C.

40. The method of any one of claims 31 to 39, wherein the reaction is carried out for a time of about 2 hours to about 6 hours.

41. The method of any one of claims 31 to 39, wherein the reaction is carried out for a time of about 3 hours to about 4 hours.

42. The method of any one of claims 31 to 41, comprising agitation during the reaction.

43. The method of any one of claims 31 to 42, wherein the method further comprises separating the particles comprising the MnO₂ from the aqueous environment.

44. The method of claim 43, wherein the method further comprises washing the separated particles comprising the MnO₂.

45. The method of claim 43 or 44, wherein the method further comprises drying the separated and optionally washed particles comprising the MnO₂.

46. The method of any one of claims 31 to 45, wherein the method further comprises reacting the manganese (II) salt with the oxidizing agent in the presence of a carbon-based material to obtain the particles comprising MnO₂ in the form of a composite comprising the MnO₂ deposited on the surface of the carbon-based material.

47. The method of claim 46, wherein the carbon-based material is selected from graphene, carbon nanofibers (CNF), carbon nanotubes (CNT), carbon black (CB) and mixtures thereof.

48. A particle comprising MnO₂ prepared according to a method of any one of claims 31 to 47.

49. A particle comprising MnO₂, wherein the particle is substantially spherical and comprises rod-like extensions with flat ends radiating outwardly from the center of the particle.

50. The particle of claim 49, wherein the rod-like extensions have an average length of about 200 nm to about 500 nm and an average width of about 20 nm to about 50 nm.

51. The particle of claim 49 or 50 or prepared by a method as defined in any one of claims 31 to 45, wherein the average diameter of the particle is from about 1.5 μm to about 4 μm.

52. The particle of any one of claims 49 to 51, or prepared by a method as defined in any one of claims 31 to 45, wherein the Brunauer-Emmett-Teller (B.E.T.) surface area of the particle is from about 35 m²/g to about 100 m²/g.

53. The particle of any one of claims 48 to 52, wherein the MnO₂ comprises γ-MnO₂.

54. A cathode comprising a particle as defined in any one of claims 48 to 53.

55. An electrochemical cell comprising the cathode of claim 54.

56. A rechargeable electrochemical cell, comprising:
a cathode comprising a particle as defined in any one of claims 48 to 53;
an anode comprising zinc; and
an aqueous electrolyte comprising a zinc salt and optionally a manganese salt, wherein the aqueous electrolyte has a pH of from about 3 to about 7.

57. The rechargeable electrochemical cell of claim 56, further comprising a separator separating the cathode and the anode.

58. The rechargeable electrochemical cell of claim 56 or 57, wherein the aqueous electrolyte has a pH of from about 3.8 to about 5.

59. The rechargeable electrochemical cell of any one of claims 56 to 58, wherein the zinc salt is zinc sulfate and the aqueous electrolyte comprises the manganese salt, wherein the manganese salt is manganese (II) sulfate.

60. The rechargeable electrochemical cell of any one of claims 56 to 59, wherein the aqueous electrolyte further comprises an alkali metal salt, an alkaline earth metal salt, an anionic surfactant, ethylene glycol, silicon dioxide or combinations thereof.

61. The rechargeable electrochemical cell of claim 60, wherein the aqueous electrolyte comprises zinc sulfate, manganese (II) sulfate and magnesium sulfate.

62. The rechargeable electrochemical cell of claim 60 or 61, wherein the aqueous electrolyte comprises the ethylene glycol.

63. The rechargeable electrochemical cell of any one of claims 60 to 62, wherein the aqueous electrolyte comprises the anionic surfactant and wherein the anionic surfactant is magnesium lauryl sulfate, potassium lauryl sulfate, lithium lauryl sulfate or combinations thereof.

64. The rechargeable electrochemical cell of claim 63, wherein the anionic surfactant is magnesium lauryl sulfate.

65. The rechargeable electrochemical cell of any one of claims 56 to 64, wherein the anode comprising zinc is a zinc foil that has been etched with acid.

66. The rechargeable electrochemical cell of claim 65, wherein the etching with acid is for a time of about 1 minute with sulfuric acid having a concentration of about 3 M.

67. The rechargeable electrochemical cell of any one of claims 56 to 66, wherein the cathode is deposited on a carbon-based current collector comprising graphite foil, carbon fiber paper, carbon cloth or combinations thereof.

68. The rechargeable electrochemical cell of any one of claims 56 to 67, that is a coin cell, a cylindrical cell, a pouch cell or a prismatic cell.

69. A rechargeable electrochemical cell, comprising:
a cathode;
an anode comprising zinc; and
an aqueous electrolyte comprising a zinc salt, a manganese salt, and an alkali metal salt, an alkaline earth metal salt or combinations thereof,
wherein the aqueous electrolyte has a pH of from about 3 to about 7.

70. The rechargeable electrochemical cell of claim 39, wherein the zinc salt is zinc sulfate, and the manganese salt is manganese (II) sulfate.

71. The rechargeable electrochemical cell of claim 69 or 70, wherein the aqueous electrolyte comprises the alkali metal salt.

72. The rechargeable electrochemical cell of claim 71, wherein the alkali metal salt is potassium sulfate.

73. The rechargeable electrochemical cell of claim 69 or 70, wherein the aqueous electrolyte comprises the alkaline earth metal salt.

74. The rechargeable electrochemical cell of claim 73, wherein the alkaline earth metal salt is magnesium sulfate.

75. The rechargeable electrochemical cell of any one of claims 69 to 74, wherein the aqueous electrolyte comprises about 1 M zinc sulfate, about 0.1 M manganese (II) sulfate and about 0.5 M magnesium sulfate.

76. The rechargeable electrochemical cell of any one of claims 69 to 75, further comprising a separator separating the cathode and the anode.

77. The rechargeable electrochemical cell of any one of claims 69 to 76, wherein the aqueous electrolyte has a pH of from about 3.8 to about 5.

78. The rechargeable electrochemical cell of any one of claims 69 to 77, wherein the aqueous electrolyte further comprises an anionic surfactant.

79. The rechargeable electrochemical cell of claim 78, wherein the anionic surfactant is magnesium lauryl sulfate, potassium lauryl sulfate, lithium lauryl sulfate or combinations thereof.

80. The rechargeable electrochemical cell of claim 79, wherein the anionic surfactant is magnesium lauryl sulfate.

81. The rechargeable electrochemical cell of any one of claims 69 to 80, wherein the aqueous electrolyte further comprises ethylene glycol.

82. The rechargeable electrochemical cell of claim 81, wherein the aqueous electrolyte comprises at least about 0.5 vol % ethylene glycol mixed with a secondary organic additive agent selected from salicylaldehyde (SAL), benzylideneacetone (BDA), benzylacetone (BA), butylbenzene (BB) and combinations thereof.

83. The rechargeable electrochemical cell of any one of claims 69 to 82, wherein the aqueous electrolyte further comprises silicon dioxide.

84. The rechargeable electrochemical cell of any one of claims 69 to 83, wherein the cathode comprises a manganese oxide, a zinc manganese oxide, a manganese-zinc hydrated sulfate hydroxide, a zinc hydroxide sulfate hydrate, or combinations thereof.

85. The rechargeable electrochemical cell of any one of claims 69 to 84, wherein the cathode comprises MnO₂.

86. The rechargeable electrochemical cell of claim 85, wherein the MnO₂ is undoped MnO₂.

87. The rechargeable electrochemical cell of claim 85, wherein the MnO₂ comprises γ-MnO₂.

88. The rechargeable electrochemical cell of claim 85, wherein the MnO₂ comprises MnO₂ particles having a hierarchical structure.

89. The rechargeable electrochemical cell of any one of claims 69 to 88, wherein the anode comprising zinc is a zinc foil.

90. The rechargeable electrochemical cell of any one of claims 69 to 89, wherein the anode comprising zinc has been etched with acid.

91. The rechargeable electrochemical cell of claim 90, wherein the etching with acid is for a time of about 1 minute with sulfuric acid having a concentration of about 3 M.

92. The rechargeable electrochemical cell of any one of claims 69 to 91, further comprising a cathode current collector.

93. The rechargeable electrochemical cell of claim 92, wherein the cathode is deposited on a carbon-based current collector comprising graphite foil, carbon fiber paper, carbon cloth or combinations thereof.

94. The rechargeable electrochemical cell of any one of claims 69 to 93, that is a coin cell, a cylindrical cell, a pouch cell or a prismatic cell.

95. A method of preparing an anode comprising zinc for use in an electrochemical cell, the method comprising contacting the zinc with an acid to etch a surface of the zinc.

96. The method of claim 95, wherein the acid is an inorganic acid.

97. The method of claim 95 or 96, wherein the acid is sulfuric acid.

98. The method of any one of claims 95 to 97, wherein the etching with acid is for a time of about 1 minute with sulfuric acid having a concentration of about 3 M.

99. The method of any one of claims 95 to 98, wherein the electrochemical cell is as defined in any one of claims 1 to 3, 6 to 24, 56 to 64, or 67 to 89.
